(19) United States
(12) Patent Application Publication
(10) Pub. No.: US 2014/0035793 A1
(43) Pub. Date: Feb. 6, 2014

(54) ANTENNA DEVICE AND COMMUNICATION TERMINAL APPARATUS

(71) Applicant: MURATA MANUFACTURING CO., LTD., Nagaokakyo-shi (JP)

(72) Inventors: Noboru KATO, Nagaokakyo-shi (JP); Masahiro OZAWA, Nagaokakyo-shi (JP)

(73) Assignee: MURATA MANUFACTURING CO., LTD., Nagaokakyo-shi (JP)

(21) Appl. No.: 14/056,011

(22) Filed: Oct. 17, 2013

Related U.S. Application Data
(63) Continuation of application No. PCT/JP2012/060321, filed on Apr. 17, 2012.

(30) Foreign Application Priority Data
Apr. 18, 2011 (JP) 2011-091976

(51) Int. Cl. H01Q 21/24

(52) U.S. Cl. CPC H01Q 21/24
USPC 343/867

(57) ABSTRACT

An antenna device includes a body and first and second coil antennas. Each coil conductor of the first and second coil antennas is provided at least one of inside and on a surface of the body. The first coil antenna includes a winding axis intersecting at least one side surface of the body. The second coil antenna includes a winding axis intersecting first and second main surfaces of the body.

### BACKGROUND OF THE INVENTION

1. Field of the Invention

The present invention relates to an antenna device and, relates to an antenna device for use as a built-in antenna for mobile communication terminals, for example.

2. Description of the Related Art

As a system for identifying and managing goods, an RFID system is known which communicates between a reader/writer and an RFID (Radio Frequency Identification) tag in a non-contact manner and transmits information between the reader/writer and the RFID tag. In this RFID system, predetermined information is transmitted/received as a high-frequency signal between the antenna of the RFID tag and the antenna of the reader/writer.

Coil antennas formed by winding a conductor wire into a coil shape are common among antennas for use in HF-band (13.56 MHz band) RFID systems. As such a coil antenna, a planar coil antenna formed by winding a conductor pattern in a planar manner on a substrate surface is generally used, for example, as disclosed in WO2009/081683.

As disclosed in Japanese Patent Laying-Open No. 2009-206974, a coil antenna formed by winding a conductor wire such that the normal to an opening surface of a coil is inclined to the winding axis of the coil is also known.

In the planar coil antenna as disclosed in WO 2009/081683 above, the magnetic flux density in the direction of the winding axis is high, whereas the magnetic flux density in the other directions is not high. As a result, although a sufficient communication distance can be ensured in the direction of the winding axis, the communication distance in the direction at 45 to 90 degrees to the winding axis is not enough.

On the other hand, in a three-dimensional coil antenna disclosed in Japanese Patent Laying-Open No. 2009-206974 above, the directivity in the direction inclined to the winding axis to some degree can be enhanced. However, it is still difficult to have a sufficient communication distance in the direction inclined at 45 degrees or greater to the winding axis.

In general, when a coil antenna is attached to a printed circuit board (printed board), the coil antenna is attached such that the winding axis thereof is vertical or parallel to the surface of the printed board. The direction in which the coil antenna has sufficient sensitivity is therefore limited to the direction vertical or parallel to the surface of the printed board. In conventional coil antennas, a special technique such as attaching a coil antenna obliquely to the printed board is required in order to achieve sufficient directivity in the direction inclined to the surface of the printed board.

Moreover, when metals such as wiring and ground are provided in a printed circuit board installed with a coil antenna, or when metal parts such as chip capacitors or IC chips are arranged around the installed coil antenna, these metals prevent formation of a magnetic flux and make it impossible to ensure a sufficient communication distance. In conventional coil antennas, it is difficult to form a magnetic flux so as to avoid these metals because the magnetic flux density is the largest in the direction of the winding axis of the coil.

### SUMMARY OF THE INVENTION

Preferred embodiments of the present invention provide an antenna device in which magnetic flux density in a direction inclined to a winding axis of a coil antenna is significantly increased.

An antenna device according to a preferred embodiment of the present invention includes a body, a first coil antenna, a second coil antenna, and a conductor layer. The body includes first and second main surfaces opposed to each other and one or more side surfaces connected to the first and second main surfaces. The first coil antenna includes a coil conductor located at least one of inside and on a surface of the body and has a winding axis intersecting at least one of the one or more side surfaces. The second coil antenna includes a coil conductor located at least one of inside and on a surface of the body and has a winding axis intersecting the first and second main surfaces. The conductor layer is arranged opposite to the second main surface. The first and second coil antennas are arranged such that the second coil antenna is positioned farther from the second main surface than the first coil antenna.

Preferably, the first and second coil antennas are arranged such that one opening surface of the second coil antenna can be seen from one opening surface of the first coil antenna without being blocked by the coil conductors of the first and second coil antennas.

In a preferred embodiment of the present invention, the first and second coil antennas are connected in series or in parallel with an external feed circuit and are magnetically coupled to each other. In this case, the first and second coil antennas are wound in such a direction that when the one opening surface of the first coil antenna serves as an entrance of magnetic flux, the one opening surface of the second coil antenna serves as an exit of magnetic flux, or in such a direction that when the one opening surface of the first coil antenna serves as an exit of magnetic flux, the one opening surface of the second coil antenna serves as an entrance of magnetic flux.

In another preferred embodiment of the present invention, one coil antenna of the first and second coil antennas is used as a feed element. In this case, the other coil antenna of the first and second coil antennas is used as a non-feed element and is magnetically coupled to the one coil antenna.

Preferably, the body is a structure including a plurality of insulating layers stacked in a direction intersecting the first and second main surfaces. In this case, the second coil antenna includes a planar coil located on a surface of at least one of a plurality of insulating layers that constitute the stack structure.

Preferably, the body includes first, second and third regions. The first region includes one or more stacked insulating layers. The second region includes one or more stacked insulating layers provided between the first region and the second main surface. The third region is provided between the first region and the second region and includes one or more stacked insulating layers having a permeability higher than a permeability of the first and second regions. In this case, the first coil antenna includes a portion of the third region inside. A portion of the coil conductor of the first coil antenna is provided at least one of inside and on a surface of the first region. The coil conductor of the second coil antenna is provided at least one of inside and on a surface of the first region.

Preferably, the body includes first and second regions. The first region includes one or more stacked insulating layers. The second region is provided between the first region and the second main surface and having a permeability higher than a permeability of the first region. In this case, the coil conductor of the first coil antenna and the coil conductor of the second coil antenna are provided at least one of inside and on a surface of the first region.

Preferably, the body includes a ferromagnetic material. In this case, at least portion of the coil conductor of the first coil antenna and at least a portion of the coil conductor of the second coil antenna are provided on a surface of the body.

Preferably, the antenna device further includes a conductive layer arranged in proximity to the first main surface so as to extend along the first main surface. The conductive layer has a hole portion passing through the conductive layer in a vertical direction and a notch portion reaching the hole portion. When viewed two-dimensionally from a direction vertical to the first main surface, the hole portion of the conductive layer is arranged so as to overlap an opening surface of the second coil antenna on a side proximate to the conductive layer. When viewed two-dimensionally from a direction vertical to the first main surface, the coil conductor of the second coil antenna is covered with the conductive layer excluding the notch portion.

In the case where the conductive layer is provided as described above, further preferably, when viewed two-dimensionally from a direction vertical to the first main surface, the notch portion is provided on a side opposite to the first coil antenna with the opening surface of the second coil antenna on the side proximate to the conductive layer.

Preferably, the second main surface is used as a surface attached to a base material at least partially including a metal. The conductor layer constitutes at least a portion of the metal included in the base material.

Preferably, an outer diameter and an inner diameter of the coil conductor of the second coil antenna are greater than an outer shape and an inner diameter, respectively, of the coil conductor of the first coil antenna.

Preferably, the antenna device further includes a third coil antenna including a coil conductor provided at least one of inside and on a surface of the body, and including a winding axis intersecting at least one of the one or more side surfaces. When viewed two-dimensionally from a direction vertical to the first main surface, the third coil antenna is arranged on a side opposite to the first coil antenna with the second coil antenna interposed. A direction of the winding axis of the third coil antenna is parallel or approximately parallel to a direction of the winding axis of the first coil antenna. The second and third coil antennas are arranged such that the second coil antenna is positioned farther from the second main surface than the third coil antenna.

Alternatively, preferably, the antenna device further includes a third coil antenna including a coil conductor provided at least one of inside and on a surface of the body, and including a winding axis intersecting the first and second main surfaces. When viewed two-dimensionally from a direction vertical to the first main surface, the third coil antenna is arranged on a side opposite to the second coil antenna with the first coil antenna interposed. The first and third coil antennas are arranged such that the third coil antenna is positioned farther from the second main surface than the first coil antenna.

In the case where the third coil antenna is additionally provided, preferably, the first to third coil antennas are connected in series or in parallel with an external feed circuit and are magnetically coupled to each other.

In the case where the third coil antenna is additionally provided, preferably, a portion of the first, second or third coil antennas is used as a feed element. In this case, the rest of the first to third coil antennas excluding the portion is used as a non-feed element and is magnetically coupled to the portion.

An antenna device according to another preferred embodiment of the present invention includes first and second bodies, first to fourth coil antennas, and a conductor layer. The first and second bodies each include first and second main surfaces opposed to each other and one or more side surfaces connecting to the one and second main surfaces. The second main surfaces of the first and second bodies are attached to a common substrate. The first coil antenna includes a coil conductor provided at least one of inside and on a surface of the first body and includes a winding axis intersecting at least one of the one or more side surfaces of the first body. The second coil antenna includes a coil conductor provided at least one of inside and on a surface of the first body and includes a winding axis intersecting the first and second main surfaces of the first body. The third coil antenna includes a coil conductor provided at least one of inside and on a surface of the second body and includes a winding axis intersecting at least one of the one or more side surfaces of the second body. The fourth coil antenna includes a coil conductor provided at least one of inside and on a surface of the second body and includes a winding axis intersecting the first and second main surfaces of the second body. The conductor layer is arranged to be opposed to the second main surface of the first body and the second main surface of the second body. When viewed two-dimensionally from a direction vertical to the substrate, the second and fourth coil antennas are arranged on opposite sides to each other with the first and third coil antennas interposed. A direction of the winding axis of the first coil antenna is parallel or approximately parallel to a direction of the winding axis of the third coil antenna. The first and second coil antennas are arranged such that the second coil antenna is positioned farther from the second main surface of the first body than the first coil antenna. The third and fourth coil antennas are arranged such that the fourth coil antenna is located farther from the second main surface of the second body than the third coil antenna.

Preferably, the antenna device further includes a coil-type booster antenna arranged in the vicinity of the plurality of coil antennas and having an outer shape larger than an outer shape of the plurality of coil antennas.

According to a further preferred embodiment of the present invention, a communication terminal apparatus includes a casing, a feed circuit provided in the casing, a printed circuit board provided in the casing and including a ground layer, and the antenna device according to one of the preferred embodiments of the present invention described above that is provided in the casing and connected to the feed circuit. The conductor layer of the antenna device constitutes at least a portion of the ground layer.

Preferably, the body is provided at a position closer to one of opposite ends in a longitudinal direction of the casing. A direction of the winding axis of the first coil antenna is parallel or approximately parallel to the longitudinal direction of the casing.

Preferably, the body includes a magnetic material region. At least a portion of the coil conductor of the first coil antenna and at least a portion of the coil conductor of the second coil antenna are provided on a surface or outside of the magnetic material region.

According to various preferred embodiments of the present invention, the magnetic flux density in a direction different from the winding axes of the first and second coil antennas of the antenna device is significantly improved.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is an external view schematically showing a configuration of an antenna device 1 in a first preferred embodiment of the present invention.

FIG. 2 is a diagram illustrating a structure of antenna device 1 in FIG. 1.

FIG. 3 is a cross-sectional view showing antenna device 1 in FIG. 1 as viewed from the Z direction parallel to a main surface 41.

FIG. 4 is a diagram schematically showing a magnetic flux generated in antenna device 1.

FIG. 5 is an external view schematically showing a configuration of an antenna device 1A as a modification of antenna device 1 in FIG. 1.

FIG. 6 is a cross-sectional view showing antenna device 1A in FIG. 5 as viewed from the Z direction parallel to main surface 41.

FIG. 7 is an external view schematically showing a configuration of an antenna device 1B as a modification of antenna device 1A in FIG. 5 and FIG. 6.

FIG. 8 is a cross-sectional view showing antenna device 1B in FIG. 7 as viewed from the Z direction parallel to main surface 41.

FIG. 9 is a cross-sectional view schematically showing an example of a portable communication terminal 70 installed with antenna device 1A in FIG. 5.

FIG. 10 is a cross-sectional view schematically showing another example of a portable communication terminal installed with antenna device 1A in FIG. 5.

FIG. 11 is a diagram illustrating a specific arrangement of antenna device 1A in portable communication terminal 71 in FIG. 10.

FIG. 12 is a diagram illustrating another specific arrangement of antenna device 1A in portable communication terminal 71 in FIG. 10.

FIG. 13 is an external view showing an example in which an antenna device having the structure in FIG. 1 is applied to an RFID tag.

FIG. 14 is a cross-sectional view schematically showing a configuration of an antenna device 3 as another modification of antenna device 1 in FIG. 1.

FIG. 15 is a cross-sectional view schematically showing a configuration of an antenna device 4 as a further modification of antenna device 1 in FIG. 1.

FIG. 16 is an external view schematically showing a configuration of an antenna device 5 in a second preferred embodiment of the present invention.

FIG. 17 is a diagram illustrating a specific arrangement of antenna device 5 when antenna device 5 shown in FIG. 16 is installed in a portable communication terminal 71.

FIG. 18 is an external view schematically showing a configuration of an antenna device 6 in a third preferred embodiment of the present invention.

FIG. 19 is a cross-sectional view showing antenna device 6 in FIG. 18 as viewed from the Z direction parallel to main surface 41.

FIG. 20 is a diagram schematically showing a magnetic flux FL generated in antenna device 6.

FIG. 21 is an external view schematically showing a configuration of an antenna device 6A as a modification of antenna device 6 in FIG. 18.

FIG. 22 is a cross-sectional view showing antenna device 6A in FIG. 21 as viewed from the Z direction parallel to main surface 41.

FIG. 23 is an external view schematically showing a configuration of an antenna device 6B as another modification of antenna device 6 in FIG. 18.

FIG. 24 is a cross-sectional view showing antenna device 6B in FIG. 23 as viewed from the Z direction parallel to main surface 41.

FIG. 25 is a diagram illustrating an arrangement of antenna device 6 when antenna device 6 shown in FIG. 18 is installed in portable communication terminal 71B.

FIG. 26 is a cross-sectional view schematically showing a configuration of an antenna device 7 in a fourth preferred embodiment of the present invention.

FIG. 27 is a cross-sectional view schematically showing a configuration of an antenna device 8 in a fifth preferred embodiment of the present invention.

FIG. 28 is a cross-sectional view schematically showing a configuration of an antenna device 9 in a sixth preferred embodiment of the present invention.

FIG. 29 is an external view schematically showing a configuration of an antenna device 100 in a seventh preferred embodiment of the present invention.

FIG. 30 is a cross-sectional view showing antenna device 100 in FIG. 29 as viewed from the Z direction parallel to main surface 41.

FIG. 31 is an external view schematically showing a configuration of an antenna device 101 in an eighth preferred embodiment of the present invention.

FIG. 32 is a cross-sectional view showing antenna device 101 in FIG. 31 as viewed from the Z direction parallel to main surface 41.

FIG. 33 is an external view schematically showing a configuration of an antenna device 102 in a ninth preferred embodiment of the present invention.

FIG. 34 is an exploded perspective view schematically showing a configuration of a booster antenna 130 in FIG. 33.

FIG. 35 is an equivalent circuit diagram of booster antenna 130 in FIG. 34.

FIG. 36 is an equivalent circuit diagram of an antenna device 102 in FIG. 33.

FIG. 37 is a plan view of antenna device 102.

FIG. 38 is a cross-sectional view of a communication terminal apparatus with antenna device 102.

FIG. 39 is an external view schematically showing a configuration of an antenna device 103 in a tenth preferred embodiment of the present invention.

FIG. 40 is a cross-sectional view showing antenna device 103 in FIG. 39 as viewed from the Z direction parallel to main surface 41.

FIG. 41 is an external view schematically showing a configuration of an antenna device 104 in an eleventh preferred embodiment of the present invention.

FIG. 42 is a cross-sectional view showing antenna device 104 in FIG. 41 as viewed from the Z direction parallel to main surface 41.

FIG. 43 is an external view schematically showing a configuration of an antenna device 105 in a twelfth preferred embodiment of the present invention.

FIG. 44 is a cross-sectional view showing antenna device 105 in FIG. 43 as viewed from the Z direction parallel to a substrate 73.

FIG. 45 is a diagram showing a configuration in which booster antenna 130 shown in FIG. 34 is added to antenna device 105 in FIG. 43.

FIG. 46 is a partially enlarged view of FIG. 45.

FIG. 47 is an external view schematically showing a configuration of an antenna device 106 in a thirteenth preferred embodiment of the present invention.

FIG. 48 is a cross-sectional view showing antenna device 106 in FIG. 47 as viewed from the Z direction parallel to substrate 73.

### DETAILED DESCRIPTION OF THE PREFERRED EMBODIMENTS

Preferred embodiments of the present invention will be described in details below with reference to the figures. It is noted that the same or corresponding elements are denoted with the same reference signs and a description thereof will not be repeated.

### First Preferred Embodiment

An antenna device according to a first preferred embodiment of the present invention preferably is configured as a built-in antenna for a mobile communication system and is used as a reader/writer-side antenna or a tag-side antenna for the HF band, for example, such as Felica (registered trademark) and NFC (Near Field Communication).

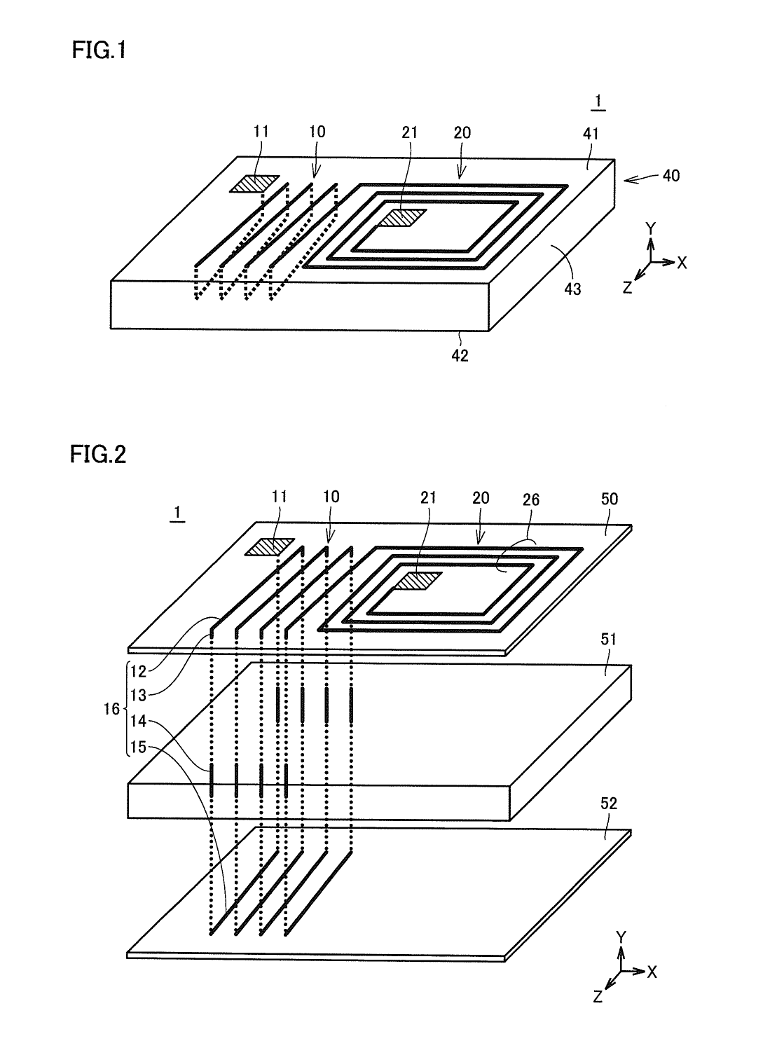

FIG. 1 is an external view schematically showing a configuration of an antenna device 1 in a first preferred embodiment of the present invention.

FIG. 2 is a diagram illustrating a structure of antenna device 1 in FIG. 1.

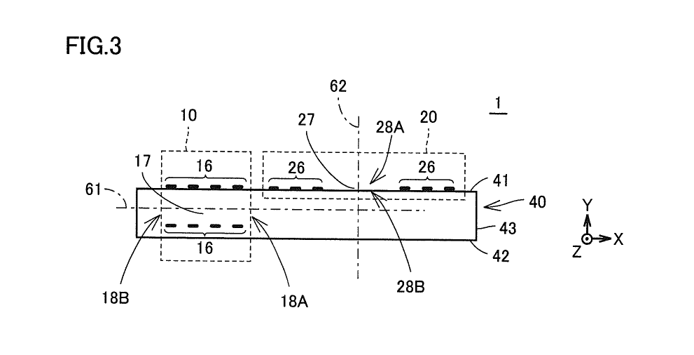

FIG. 3 is a cross-sectional view showing antenna device 1 in FIG. 1 as viewed from the Z direction parallel to a main surface 41.

Referring to FIG. 1 to FIG. 3, antenna device 1 includes a body 40 including a dielectric or an insulating magnetic material, or including both, a first coil antenna 10 including a winding axis extending approximately in the X direction, and a second coil antenna 20 including a winding axis extending approximately in the Y direction and electrically connected in series with first coil antenna 10.

In the following, a space in first coil antenna 10 that is surrounded by a coil conductor (winding conductor) 16 as shown in FIG. 3 is referred to as a hollow portion 17. A winding axis 61 refers to the central axis around which coil conductor 16 is wound. The opposite end surfaces of hollow portion 17 in the direction of the winding axis 61 are referred to as opening surfaces 18A and 18B. Similarly, a space in second coil antenna 20 that is surrounded by a coil conductor 26 is referred to as a hollow portion 27 (the thickness of hollow portion 27 is equal to the thickness of coil conductor 26). A winding axis 62 refers to the center axis around which coil conductor 26 is wound. The opposite end surfaces of hollow portion 27 in the direction of winding axis 62 are referred to as opening surfaces 28A and 28B.

In the first preferred embodiment, body 40 preferably has a rectangular or substantially rectangular parallelepiped shape including a first main surface 41, a second main surface 42 opposed to first main surface 41, and four side surfaces 43 connecting first and second main surfaces 41 and 42. First and second main surfaces 41 and 42 are arranged along a plane vertical to the Y direction, that is, the XZ plane. When antenna device 1 is installed in a communication terminal, second main surface 42 serves as a surface attached to a printed circuit board provided in the communication terminal.

In the case in FIG. 1 to FIG. 3, coil conductor 16 of coil antenna 10 is located on a surface and inside of body 40, and coil conductor 26 of coil antenna 20 is located on a surface of body 40. The winding axis of first coil antenna 10 intersects two side surfaces 43 opposed to each other. The winding axis of second coil antenna 20 intersects first and second main surfaces 41 and 42.

Unlike the case in FIG. 1 to FIG. 3, coil conductors 16 and 26 of coil antennas 10 and 20 may both be provided inside body 40. More generally speaking, coil conductor 16 of first coil antenna 10 is located inside body 40, or extends from the inside of body 40 to at least one of first and second main surfaces 41 and 42, or is located on a surface of body 40. Coil conductor 26 of second coil antenna 20 is located inside body 40, or on main surface 41, or extends from the inside of body 40 to first main surface 41.

However, when a magnetic material portion is included in body 40, at least a portion of coil antenna 10 and at least a portion of coil antenna 20 are preferably provided on a surface or outside of the magnetic material portion. When body 40 is entirely made of a magnetic material, a portion of coil antenna and at least a portion of coil antenna 20 are preferably provided on a surface of body 40. This is because when coil antennas 10 and 20 are located inside the magnetic material, a magnetic circuit closed inside the magnetic material is provided, so that a magnetic field is not produced outside the body.

The shape of body 40 is not limited to a rectangular or substantially rectangular parallelepiped and may be any shape that includes main surfaces 41 and 42 opposed to each other (not always parallel) and one or more side surfaces 43 connecting main surfaces 41 and 42. For example, body 40 may be shaped like a post such as a column. In this case, the top and bottom surfaces of the post correspond to main surfaces 41 and 42. Side surface 43 of a column includes one curved surface. Main surfaces 41 and 42 may not have the same shape. Side surface 43 may not be orthogonal to main surfaces 41 and 42.

As described above, in the case of the body having a more general shape, the coil conductors of the first and second coil antennas are provided at least one of inside and on a surface of the body. The winding axis of the first coil antenna intersects at least one of one or more side surfaces that constitute the body, and the winding axis of the second coil antenna intersects the first and second main surfaces that constitute the body.

As shown in FIG. 2, body 40 has a structure in which a plurality of substrate layers made of an insulating material are stacked in the Y direction. Each substrate layer is preferably made of a dielectric such as thermoplastic resin or glass ceramic or a magnetic material such as ferrite powder-containing resin. Specifically, in the case in FIG. 2, body 40 is a stack structure of first to third substrate layers 50, 51, and 52.

First and second coil antennas 10 and 20 include conductor wires such as silver and copper wires, for example.

Coil conductor 16 of first coil antenna 10 includes a plurality of conductor wires 12 located on a surface of first substrate layer 50, a plurality of conductor wires 15 located on a surface of third substrate layer 52, a plurality of conductor wires 13 passing through first substrate layer 50, and a plurality of conductor wires 14 passing through second substrate layer 51. Conductor wires 12 located on a surface of first substrate layer 50 and conductor wires 15 located on a surface of third substrate layer 52 are coupled by conductor wires 13 and 14 passing through first and second substrate layers 50 and 51.

Second coil antenna 20 is a planar coil preferably formed by winding a conductor wire into a coil shape including a plurality of turns. Second coil antenna 20 is provided on first substrate layer 50, that is, on first main surface 41 of body 40 in FIG. 1.

Coil conductor 16 that defines first coil antenna 10 has one end connected to a first feed terminal 11 and the other end connected to one end of coil conductor 26 that defines second coil antenna 20. The other end of coil conductor 26 is connected to a second feed terminal 21. That is, first coil antenna 10 and second coil antenna 20 are connected in series between first feed terminal 11 and second feed terminal 21.

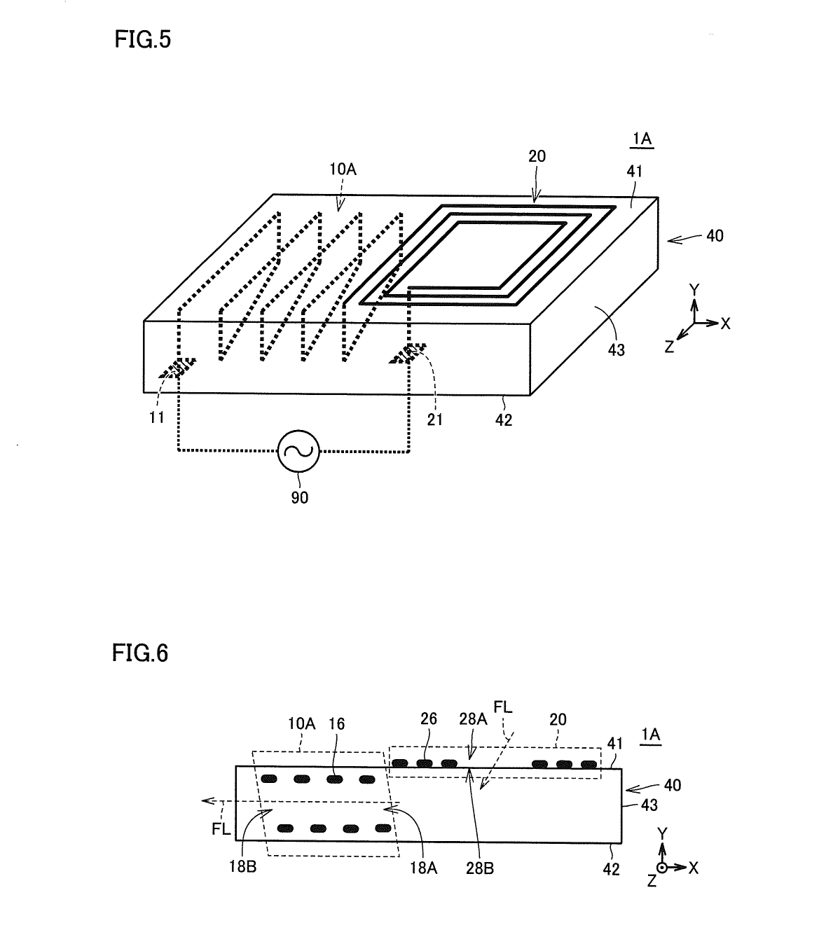

Although first and second feed terminals 11 and 21 are preferably located on first main surface 41 of body 40 in FIG. 1 and FIG. 2, they are not necessarily located on first main surface 41. Feed terminals 11 and 21 may be provided on second main surface 42 of body 40 or provided on side surface 43. An example in which feed terminals 11 and 21 are provided on second main surface 42 of body 40 will be described later with reference to FIG. 5 and FIG. 6.

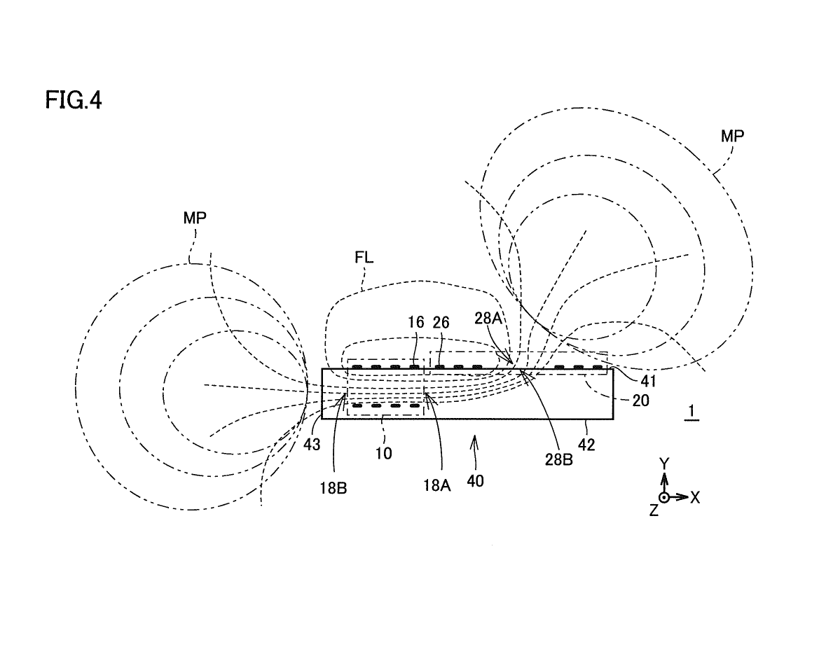

FIG. 4 is a diagram schematically showing a magnetic flux generated in antenna device 1. In FIG. 4, a magnetic flux FL is shown by a broken line, and an equipotential surface MP is shown by a two-dot chain line. Referring to FIG. 3 and FIG. 4, the arrangement and winding direction of first and second coil antennas 10 and 20 will be described below in more detail.

First and second coil antennas 10 and 20 are arranged such that second coil antenna is positioned farther from second main surface 42 than the first coil antenna 10. That is, the minimum value of the distance from any given point on the coil conductor of second coil antenna 20 to the second main surface is greater than the minimum value of the distance from any given point on the coil conductor of first coil antenna 10 to the second main surface.

Preferably, first and second coil antennas 10 and 20 are arranged so as to satisfy the following conditions.

Firstly, winding axis 61 of first coil antenna 10 intersects at least one of side surfaces 43 but does not intersect second main surface 42. In the case in FIG. 3, winding axis 61 of first coil antenna 10 is set parallel or approximately parallel to second main surface 42 and intersects two side surfaces 43 opposed to each other. In this description, “approximately parallel” means within a range of about ±10° from the parallel direction. This can prevent leakage of magnetic flux density on the second main surface 42 side used as a surface affixed to a base material such as a printed circuit board and can increase magnetic flux density on the side surface 43 side of body 40.

Secondly, winding axis 62 of second coil antenna 20 intersects first main surface 41 and second main surface 42. In the case in FIG. 3, winding axis 62 of second coil antenna 20 is perpendicular or approximately perpendicular to first main surface 41 and second main surface 42. In this description, “approximately perpendicular (approximately vertical)” means within a range of about ±10° from the orthogonal direction (vertical direction). This increases the density of a magnetic flux guided toward first main surface 41.

Thirdly, one opening surface 28B of second coil antenna 20 can be seen from one opening surface 18A of first coil antenna 10 without being blocked by coil conductors 16 and of first and second coil antennas. In other words, a line connecting any given point on opening surface 18A and any given point on opening surface 28B does not intersect coil conductors 16 and 26 (does not pass through the inside of coil conductors 16 and 26). In the case in FIG. 3, the line connecting opening surfaces 18A and 28B may touch coil conductor 26 but do not intersect coil conductor 26.

Furthermore, the outer diameter and the inner diameter of the coil conductor of second coil antenna 20 are preferably greater than the outer shape and the inner diameter, respectively, of the coil conductor of first coil antenna 10. Here, the outer shape of the coil antenna means the maximum value of the distance between any given two points on the outer periphery of the coil conductor when the coil antenna is viewed two-dimensionally along the winding axis direction. The inner diameter of the coil antenna means the maximum value of the distance between any given two points on the inner periphery of the coil conductor when the coil antenna is viewed two-dimensionally along the winding axis direction. Therefore, when the shape of the outer periphery (inner periphery) as viewed two-dimensionally is a circle, the outer shape (inner diameter) is the diameter of the circle. When the shape of the outer periphery (inner periphery) as viewed two-dimensionally is a rectangle or square, the outer shape (inner diameter) is the length of the diagonal. By setting the outer shape and the inner diameter of coil antennas 10 and 20 as described above, a magnetic flux can be introduced efficiently from first coil antenna 10 to the inside of second coil antenna 20.

Fourthly, first and second coil antennas 10 and 20 are wound in such a direction that when one of opening surface 18A of first coil antenna 10 and opening surface 28B of second coil antenna 20 serves as an entrance of magnetic flux, the other serves as an exit of magnetic flux. That is, in a case where current flows from one to the other of first and second coil antennas 10 and 20, the winding direction of first and second coil antennas 10 and 20 is set such that a magnetic line of force FL passing through one opening surface 18A of first coil antenna 10 to the outside of first coil antenna 10 passes through one opening surface 28B of second coil antenna 20 to the inside of second coil antenna 20, or a magnetic line of force FL passing through one opening surface 28B of second coil antenna 20 to the outside of second coil antenna 20 passes through one opening surface 18A of first coil antenna 10 to the inside of first coil antenna 10. By setting the winding direction in this manner, first coil antenna 10 and second coil antenna 20 can be magnetically coupled. Here, magnetic coupling refers to coupling of magnetic fields using resonance as will be described in FIG. 5 and FIG. 6.

With the third and fourth conditions above, most of the magnetic flux passing through the inside of first coil antenna 10 passes through the inside of second coil antenna 20.

The arrangement and winding direction of first and second coil antennas 10 and 20 are set so as to satisfy the first to fourth conditions above, such that magnetic flux FL is generated efficiently in the direction in which it enters side surface 43 of body 40, passes through the inside of first and second coil antennas 10 and 20, and exits first main surface 41, or in the reverse direction, as shown in FIG. 4, when signal current flows between first and second feed terminals 11 and 21. This magnetic flux FL expands in a direction different from the winding direction of each coil. Specifically speaking, a region with high magnetic flux density is produced in the side surface direction of body 40 (in the left direction in the figure), that is, in the direction of winding axis 61 of first coil antenna 10, which is the direction vertical to winding axis 62 of second coil antenna 20. In addition, a region with high magnetic flux density is produced in the direction oblique to main surface 41 of body 40 (the upper right direction in the figure), that is, in the direction 45 degrees different from winding axis 61 of first coil antenna 10 and winding axis 62 of second coil antenna 20. As a result, the communication distance is significantly increased in these directions of high magnetic flux density.

FIG. 5 is an external view schematically showing a configuration of an antenna device 1A as a modification of antenna device 1 in FIG. 1. FIG. 6 is a cross-sectional view showing antenna device 1A in FIG. 5 as viewed from the Z direction parallel to main surface 41.

Referring to FIG. 5 and FIG. 6, antenna device 1A differs from antenna device 1 described with FIG. 1 to FIG. 3 in that coil conductor 16 of a first coil antenna 10A is provided inside body 40. In the case of antenna device 1 in FIG. 1 to FIG. 3, the coil conductor of first coil antenna 10 is provided to extend from on first main surface 41 of body 40 to the inside of body 40.

Antenna device 1A further differs from antenna device in FIG. 1 to FIG. 3 in that feed terminals 11 and 21 are provided not on first main surface 41 of body 40 but on second main surface 42. Feed terminal 11 in FIG. 5 is connected to an end portion of coil conductor 16 of first coil antenna 10A through a via hole located inside body 40. Feed terminal 21 is connected to an end portion of coil conductor 26 of second coil antenna 20 through a via hole located inside body 40. A feed circuit 90 is connected to feed terminals 11 and 21.

It is advantageous that second main surface 42 is a surface attached to a printed circuit board, in that feed terminals 11 and 21 can be connected to wiring located on the printed circuit board by soldering. When second main surface 42 is a surface attached to a printed circuit board, first and second coil antennas 10A and 20 are arranged such that second coil antenna 20 is positioned farther from second main surface 42 than the first coil antenna 10A.

The other configuration of antenna device 1A in FIG. 5 and FIG. 6 is preferably the same or substantially the same as in antenna device 1 in FIG. 1 to FIG. 3. Therefore, the same or corresponding elements are denoted with the same reference signs and a detailed description thereof will not be repeated.

Antenna device 1A described above achieves the same operation effects as achieved by antenna device 1. Specifically, magnetic flux FL in the obliquely upward direction from second coil antenna 20 (the direction between the +X direction and the +Y direction in FIG. 6) is significantly increased, and the communication distance in the direction of high magnetic flux density is significantly increased. Meanwhile, the magnetic flux density leaking from second main surface 42 is significantly reduced, so that second main surface 42 can be used as a surface affixed to a base material including metals.

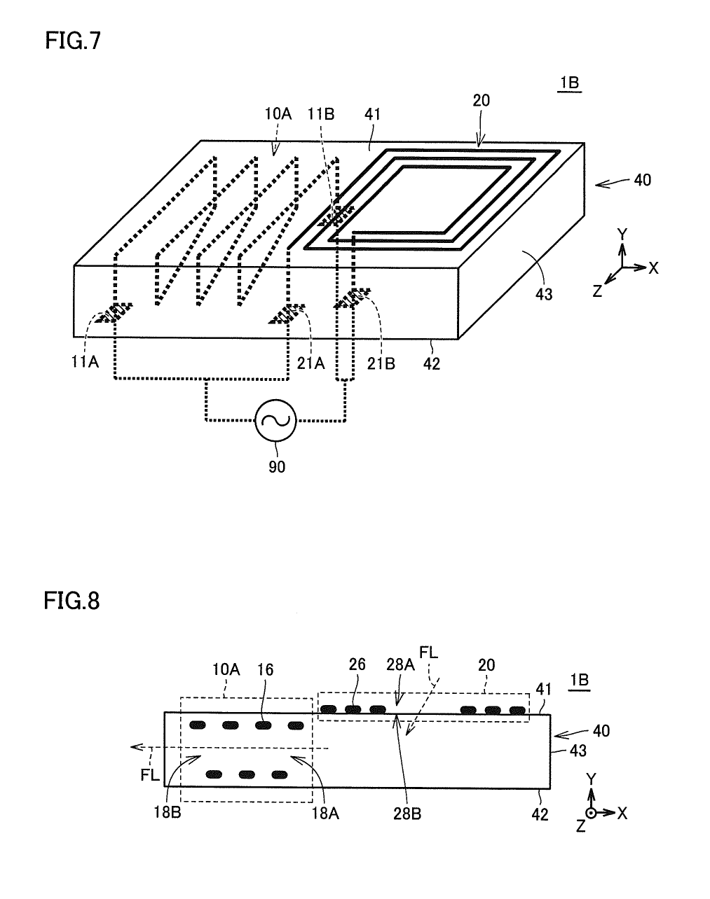

FIG. 7 is an external view schematically showing a configuration of an antenna device 1B as a modification of antenna device 1A in FIG. 5 and FIG. 6. FIG. 8 is a cross-sectional view showing antenna device 1B in FIG. 7 as viewed from the Z direction parallel to main surface 41.

Referring to FIG. 7 and FIG. 8, antenna device 1B differs from antenna device 1A in the following points. In the case of antenna device 1B, feed terminals 11A and 11B are connected to the opposite ends of coil conductor 16 that defines first coil antenna 10A, and feed terminals 21A and 21B are connected to the opposite ends of coil conductor 26 that defines second coil antenna 20. Feed terminals 11A, 11B, 21A, and 21B are provided on second main surface 42 of body 40. Wiring to connect first coil antenna 10A and second coil antenna 20 in series is not provided in body 40.

Furthermore, in the case of antenna device 1B, first and second coil antennas 10A and 20 are connected in parallel with feed circuit 90. In a case where current flows from feed circuit 90 through first and second coil antennas 10A and 20, first and second coil antennas 10A and 20 are wound in such a direction that when one of opening surfaces 18A and 28B opposed to each other serves as an entrance of magnetic flux, the other serves as an exit of magnetic flux.

Here, the following relationship is desired in terms of resonance frequency so that first coil antenna 10A and second coil antenna 20 are magnetically coupled. It is assumed that the resonance frequency of a first resonant circuit including first coil antenna 10A is f1 (for example, capacitance is provided between feed terminals 11A and 11B). It is assumed that the resonance frequency of a second resonant circuit including second coil antenna 20 is f2 (for example, capacitance is provided between feed terminals 21A and 21B). In this description, the resonance frequency of a resonant circuit including a coil antenna may be simply referred to as the resonance frequency of a coil antenna.

Given that the carrier frequency for use in commination (the frequency of carrier wave of a transmission signal and/or a reception signal) is f0, resonance frequencies f1 and f2 have to be set to values close to carrier frequency f0 and both greater than carrier frequency f0. Accordingly, the impedance between feed terminals 11A and 11B of first coil antenna 10A and the impedance between feed terminals 21A and 21B of second coil antenna 20 become inductive, so that first coil antenna 10A and second coil antenna 20 can be magnetically coupled.

The other configuration and effects of antenna device 1B in FIG. 7 and FIG. 8 are the same as in antenna device 1 described with FIG. 1 to FIG. 3. Therefore, the same or corresponding elements are denoted with the same reference signs and a description thereof will not be repeated.

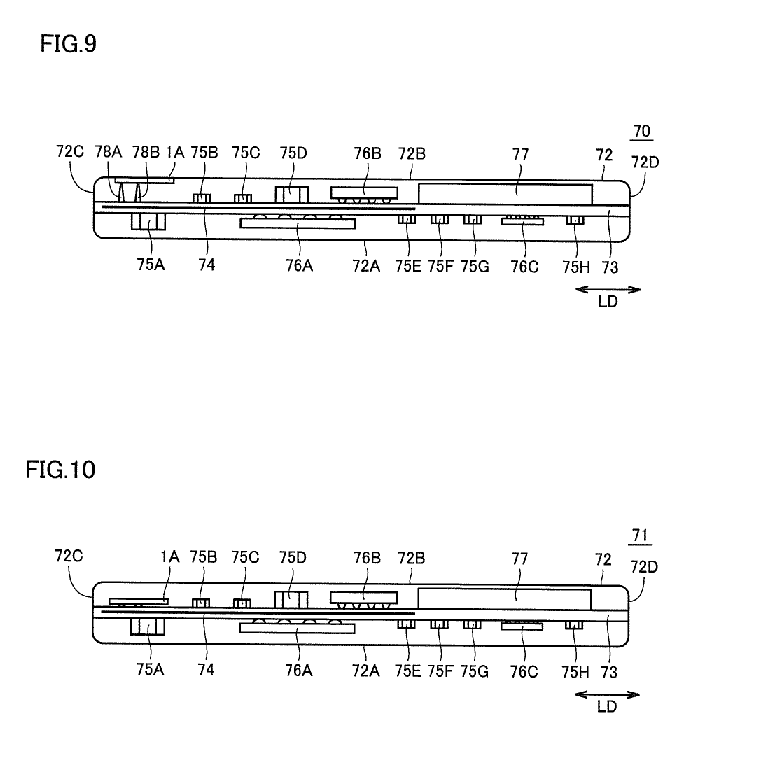

FIG. 9 is a cross-sectional view schematically showing an example of a portable communication terminal 70 installed with antenna device 1A in FIG. 5.

Referring to FIG. 9, portable communication terminal 70 includes a plastic casing 72 preferably having a rectangular or approximately rectangular parallelepiped shape, a printed circuit board 73 provided inside casing 72, and antenna device 1A. Antenna device 1A is, for example, an antenna for an RFID system of the HF band such as 13.56 MHz. The left-right direction in FIG. 9 is a longitudinal direction LD of casing 72. It is assumed that a front surface 72A of the casing is arranged below in FIG. 9, a back surface 72B of the casing is arranged above in FIG. 9, a front end portion 72C of the casing is arranged on the left in FIG. 9, and a base end portion 72D of the casing is arranged on the right in FIG. 9.

Printed circuit board 73 includes a ground layer 74 inside thereof. A plurality of electronic components 75A to 75H such as a resistance element and a capacitor, integrated circuits 76A to 76C, and a battery pack 77 are installed on the front surface side and the back surface side of printed circuit board 73. A feed circuit that outputs a transmission signal to antenna device 1A is provided in any one of integrated circuits 76A to 76C.

Antenna device 1A is provided in proximity to front end portion 72C of casing 72. Specifically, first main surface 41 of body 40 shown in FIG. 5 is bonded to the inside of back surface 72B of casing 72 preferably using an insulative adhesive, for example. Feed terminals 11 and 21 are located on second main surface 42 of body 40, and these feed terminals 11 and 21 are electrically connected to the wiring on printed circuit board 73 through feed pins 78A and 78B.

FIG. 10 is a cross-sectional view showing another example of a portable communication terminal installed with antenna device 1A in FIG. 5. A portable communication terminal shown in FIG. 10 is the same as in FIG. 9 excluding the arrangement of antenna device 1A. In the case in FIG. 10, second main surface 42 of body 40 shown in FIG. 5 is affixed to printed circuit board 73. Feed terminals 11 and 21 are located on second main surface 42 of body 40, and these feed terminals 11 and 21 are connected to a feed circuit installed in the printed circuit board through a joint member such as solder.

In the case where feed terminals 11 and 21 are located on main surface 41 of body 40 as in antenna device 1 in FIG. 1, feed terminals 11 and 21 and the feed circuit attached to the printed circuit board are connected through a bonding wire.

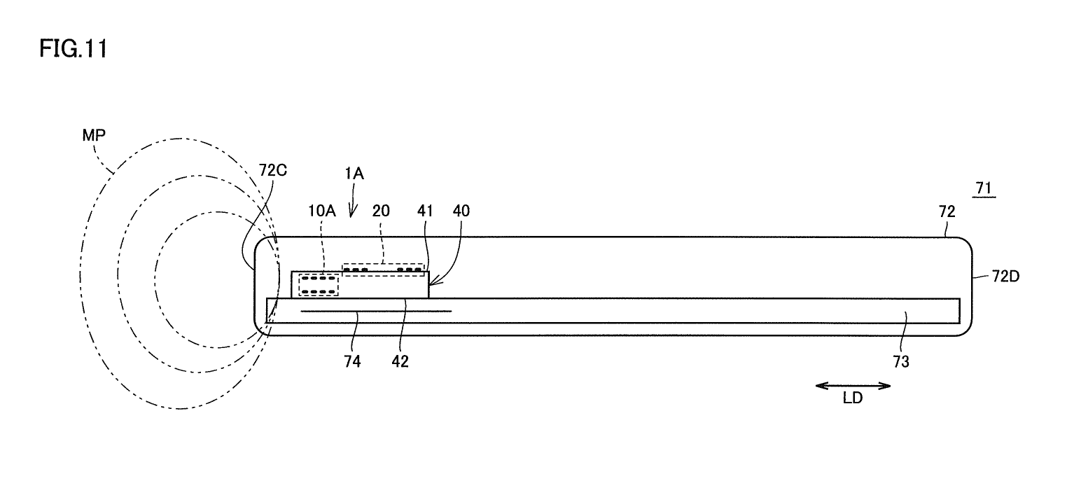

FIG. 11 is a diagram illustrating a specific arrangement of antenna device 1A in portable communication terminal 71 in FIG. 10. In the case in FIG. 11, first coil antenna 10A in FIG. 5 is arranged at a position proximate to front end portion 72C of casing 72, and second coil antenna 20 is arranged on the opposite side to front end portion 72C with first coil antenna 10A interposed. The winding axis of first coil antenna 10A is parallel or approximately parallel to longitudinal direction LD of casing 72. In this description, “approximately parallel” means within a range of about ±10° from the parallel direction.

By arranging antenna device 1A as shown in FIG. 11, a region with high magnetic flux density can be produced in longitudinal direction LD of terminal casing 72. As a result, the communication distance can be increased in longitudinal direction LD of high magnetic flux density. That is, in the case of the structure in FIG. 11, first coil antenna 10A functions as a main antenna, and second coil antenna 20 functions as a directivity control element.

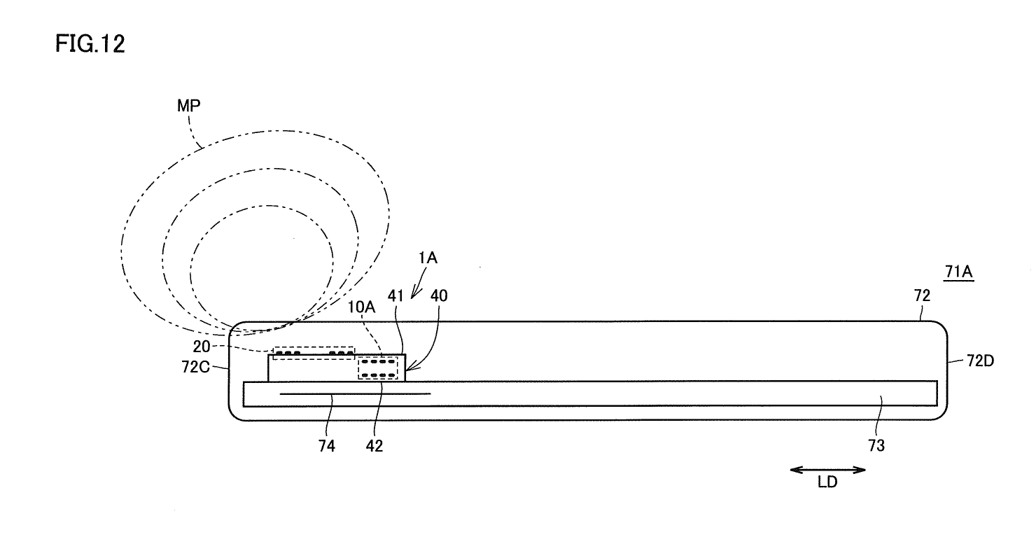

FIG. 12 is a diagram illustrating another specific arrangement of antenna device 1A in portable communication terminal 71 in FIG. 10. In the case in FIG. 12, second coil antenna 20 in FIG. 5 is arranged at a position proximate to front end portion 72C of casing 72, and first coil antenna 10A is arranged on the opposite side to front end portion 72C with second coil antenna 20 interposed. The winding axis of first coil antenna 10A is parallel or approximately parallel to longitudinal direction LD of casing 72.

By arranging antenna device 1A as shown in FIG. 12, a region with high magnetic flux density can be produced in the direction that is about 45 degrees different from longitudinal direction LD of terminal casing 72, and the communication distance can be increased in the direction of this region with high magnetic flux density. That is, in the case in FIG. 12, second coil antenna 20 functions as a main antenna, and first coil antenna 10A functions as a directivity control element.

In the case where antenna device 1A in the present preferred embodiment is installed on a metal element such as ground layer 74 as shown in FIG. 12, although ground layer 74 is located below first coil antenna 10A and second coil antenna 20, ground layer 74 has little effect. However, preferably, the outer edge of ground layer 74 is arranged more inward (to the right in the figure) than the outer edge of second coil antenna 20, such that the produced magnetic flux density is increased.

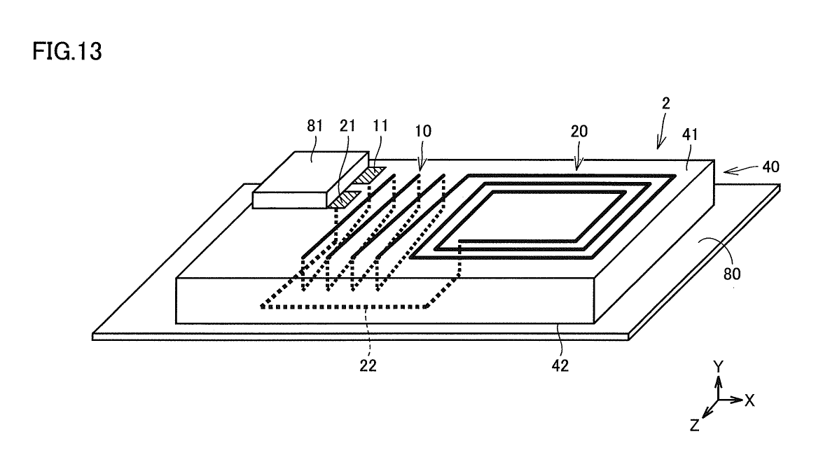

FIG. 13 is an external view showing an example in which an antenna device having the structure in FIG. 1 is applied to an RFID tag. In the case of an antenna device 2 shown in FIG. 13, feed terminal 21 is arranged in proximity to feed terminal 11, and wiring 22 connecting an end portion of second coil antenna 20 with feed terminal 21 is provided inside body 40. An IC (Integrated Circuit) chip 81 in which a communication circuit and the like are integrated is connected by soldering to feed terminals 11 and 21 provided on first main surface 41. Second main surface 42 is used as a surface attached to a base material 80.

With the arrangement of antenna device 2 as shown in FIG. 13, the magnetic flux can be enhanced in the direction in which it passes from the side surface of body 40 through the inside of first and second coil antennas 10 and 20 and exits first main surface 41, or in the reverse direction. In addition, leakage of magnetic flux toward second main surface 42 can be reduced, so as to allow the RFID tag to be affixed onto metal 80 such as a gas cylinder.

As described above, in antenna devices 1, 1A, 1B, and 2 in the present preferred embodiment, the magnetic flux density is controlled. Accordingly, even when the printed circuit board installed with the antenna device has metals such as wiring and ground, or even when metal components such as a chip capacitor and an IC chip are present in the surroundings, the magnetic flux is prevented from being affected by these metals. As a result, an antenna device that is less susceptible to these metals and achieves a sufficient communication distance is provided.

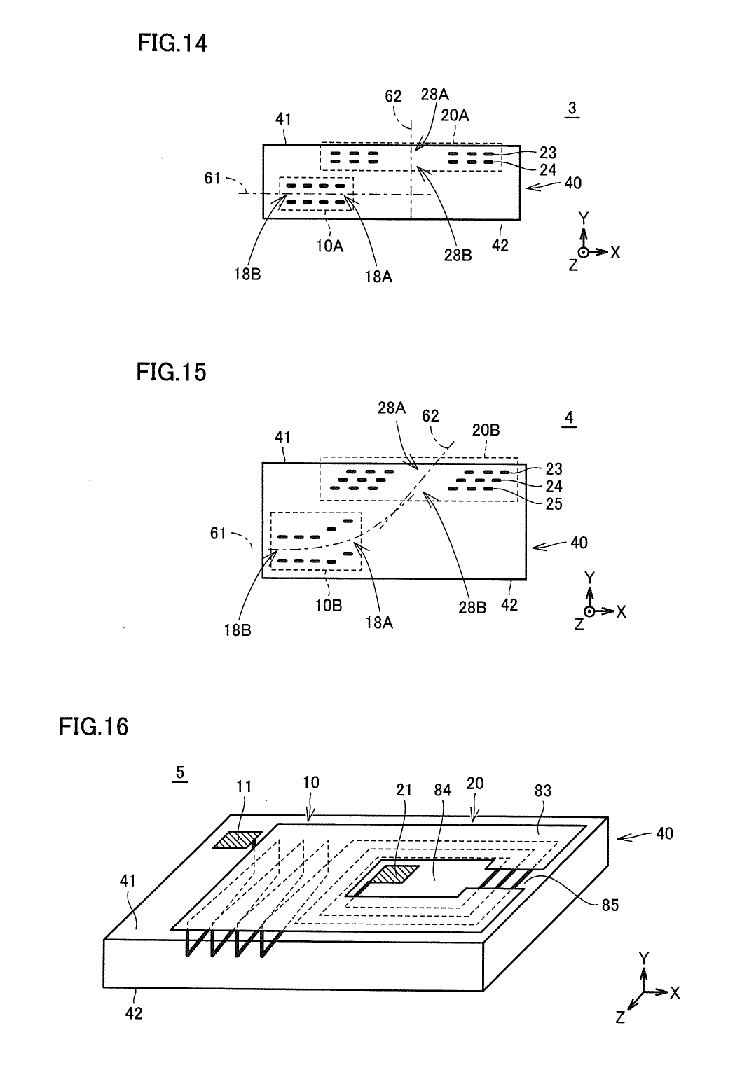

FIG. 14 is a cross-sectional view schematically showing a configuration of an antenna device 3 as another modification of antenna device 1 in FIG. 1.

In the case shown in FIG. 14, a second coil antenna 20A includes two layers of planar coils 23 and 24 stacked inside body 40. In general, body 40 includes a plurality of insulating layers stacked in the direction vertical to first main surface 41, and planar coils 23 and 24 are located on the respective surfaces of the two insulating layers. Planar coils 23 and 24 are connected by a via conductor (not shown) passing through the insulating layers. In addition, in the case in FIG. 14, when viewed two-dimensionally from the Y direction, the conductor wire that defines first coil antenna 10A and the conductor wire that defines second coil antenna 20A partially overlap each other.

Even in such an arrangement of the coils, one opening surface 28B of second coil antenna 20A can be seen from one opening surface 18A of first coil antenna 10A without being blocked by the coil conductors that define first and second coil antennas 10A and 20A. In addition, in a case where current flows from one of first and second coil antennas 10A and 20A to the other, the winding direction of first and second coil antennas 10A and 20A can be set such that the magnetic line of force passing through one opening surface 18A of first coil antenna 10A to the outside of first coil antenna 10A passes through one opening surface 28B of second coil antenna 20A to the inside of second coil antenna 20A, or such that the magnetic line of force passing through one opening surface 28B of second coil antenna 20A to the outside of second coil antenna 20A passes through one opening surface 18A of first coil antenna 10A to the inside of first coil antenna 10A. As a result, the magnetic flux density is significantly increased in the direction in which it passes from the side surface of body 40 through the inside of first and second coil antennas 10A and 20A and exits first main surface 41, or in the reverse direction.

FIG. 15 is a cross-sectional view schematically showing a configuration of an antenna device 4 as a further modification of antenna device 1 in FIG. 1.

In the case shown in FIG. 15, a second coil antenna 20B includes three layers of planar coils 23 to 25 stacked inside body 40. Winding axis 62 of second coil antenna 20B has a predetermined inclination relative to first main surface 41. First coil antenna 10B is arranged such that its inner diameter gradually increases toward second coil antenna 20B. The winding axis of first coil antenna 10B gradually goes up (the +Y direction) toward second coil antenna 20B but does not intersect second main surface 42.

Even in such an arrangement of the coils, one opening surface 28B of second coil antenna 20B can be seen from one opening surface 18A of first coil antenna 10B without being blocked by the coil conductors that define first and second coil antennas 10B and 20B. In addition, in a case where current flows from one of first and second coil antennas 10B and 20B to the other, the winding direction of first and second coil antennas 10B and 20B can be set such that the magnetic line of force passing through one opening surface 18A of first coil antenna 10B to the outside of first coil antenna 10B passes through one opening surface 28B of second coil antenna 20B to the inside of second coil antenna 20B, or such that the magnetic line of force passing through one opening surface 28B of second coil antenna 20B to the outside of second coil antenna 20B passes through one opening surface 18A of first coil antenna 10B to the inside of first coil antenna 10B. As a result, the magnetic flux is increased in the direction in which it passes from the side surface of body 40 through the inside of first and second coil antennas 10B and 20B and exits first main surface 41, or in the reverse direction.

### Second Preferred Embodiment

FIG. 16 is an external view schematically showing a configuration of an antenna device 5 in a second preferred embodiment of the present invention.

Antenna device 5 in the present preferred embodiment is provided by preferably adding a conductive layer 83 serving as a boost antenna to the antenna device in the first preferred embodiment, as shown in FIG. 16. Conductive layer 83 is arranged in proximity to first main surface 41 so as to extend along first main surface 41 of body 40. Conductive layer 83 has a hole portion 84 passing through conductive layer 83 in the vertical direction and a slit-shaped notch portion 85 reaching hole portion 84. Notch portion 85 brings hole portion 84 into communication with the outer peripheral space of conductive layer 83 and passes through conductive layer 83 in the vertical direction. When viewed two-dimensionally from the direction vertical to first main surface 41, hole portion 84 of conductive layer 83 is arranged to overlap the opening of second coil antenna 20. The coil conductor of the second coil is covered with conductive layer 83, excluding the portion of notch portion 85.

With the configuration as described above, second coil antenna 20 and conductive layer 83 are electromagnetically coupled, such that dielectric current flows through the outer periphery of conductive layer 83. Accordingly, when viewed two-dimensionally from the direction vertical to first main surface 41, the area of conductive layer 83 is preferably larger than the area surrounded by the outermost periphery of the coil conductor of second coil antenna 20 so that the magnetic flux density generated by antenna device 5 is enhanced.

Preferably, when viewed two-dimensionally from the direction vertical to first main surface 41, notch portion 85 is provided on the opposite side to first coil antenna 10 with the opening surface of second coil antenna 20 on the side proximate to conductive layer 83 being interposed. This further enhances the magnetic flux density in the direction in which notch portion 85 is provided.

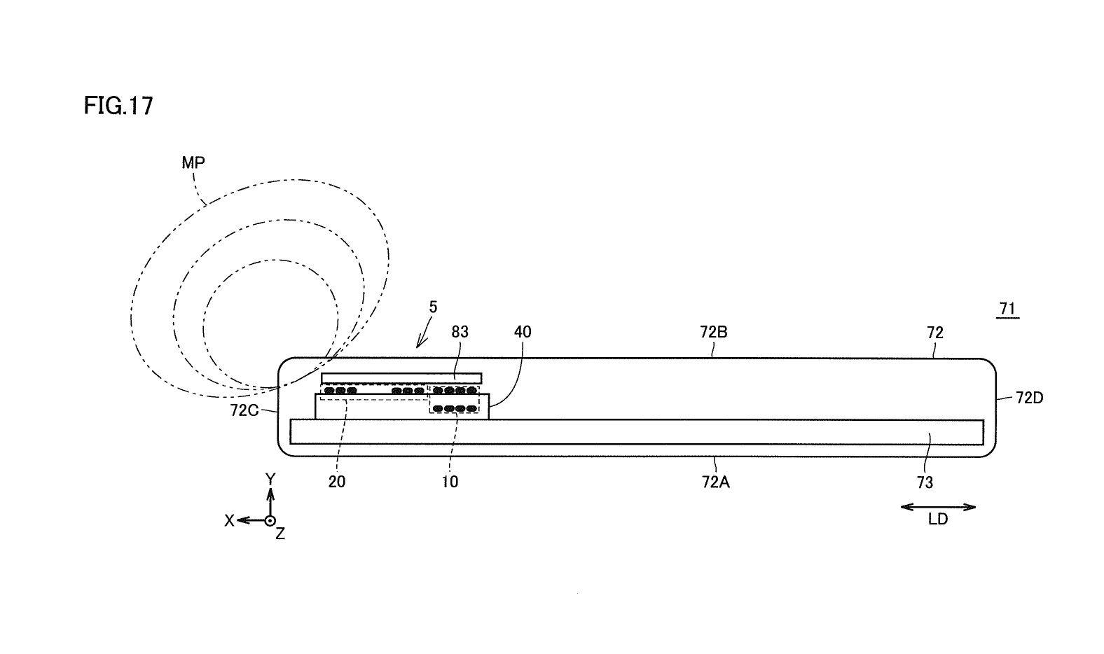

FIG. 17 is a diagram illustrating an arrangement of antenna device 5 when antenna device 5 shown in FIG. 16 is installed in portable communication terminal 71.

As shown in FIG. 17, second coil antenna 20 in FIG. 16 is arranged at a position proximate to front edge portion 72C of casing 72, and first coil antenna 10 is arranged on the opposite side to front edge portion 72C with second coil antenna 20 interposed. The winding axis of first coil antenna 10 is parallel or approximately parallel to longitudinal direction LD of casing 72.

With the arrangement of antenna device 5 as shown in FIG. 17, a region with high magnetic flux density is produced in the direction that is about 45 degrees different from longitudinal direction LD of terminal casing 72, and the communication distance is significantly increased in the direction of this region with high magnetic flux density.

### Third Preferred Embodiment

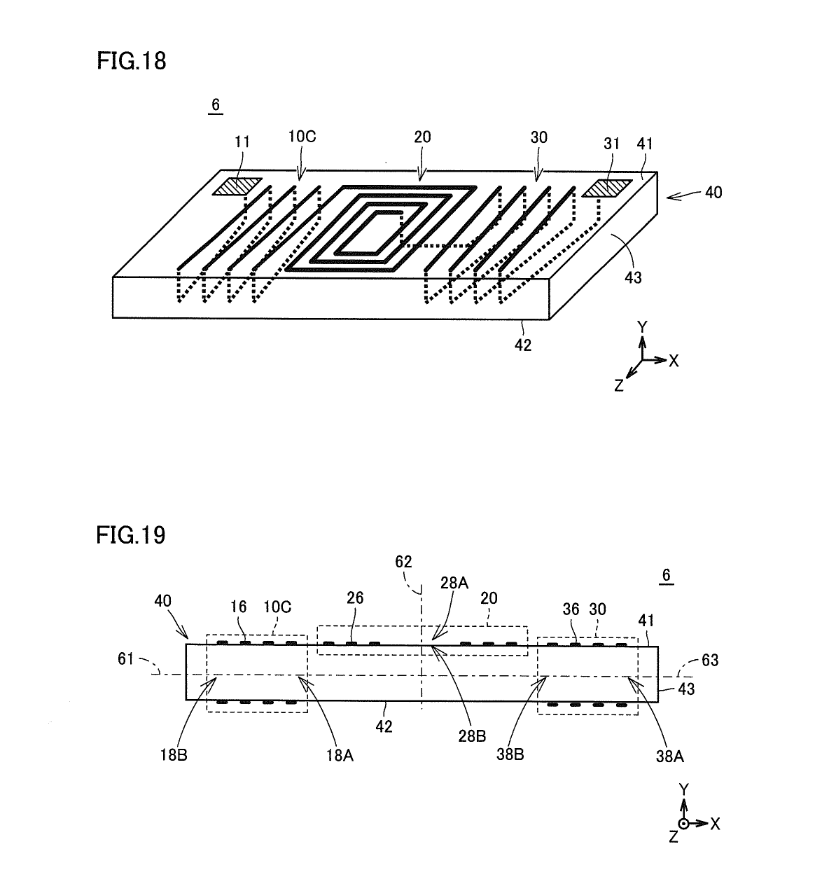

FIG. 18 is an external view schematically showing a configuration of an antenna device 6 in a third preferred embodiment of the present invention.

FIG. 19 is a cross-sectional view showing antenna device 6 in FIG. 18 as viewed from the Z direction parallel to main surface 41.

Antenna device 6 in the present preferred embodiment is preferably provided by adding a third coil antenna 30 to antenna device 1 in the first preferred embodiment, as shown in FIG. 18 and FIG. 19. In the case in FIG. 18 and FIG. 19, coil conductors 16 and 36 of first and third coil antennas 10C and 30 are arranged to extend from the inside of body 40 to both of first and second main surfaces 41 and 42.

Referring to FIG. 18 and FIG. 19, first coil antenna 10C, second coil antenna 20, and third coil antenna 30 are connected in series in this order between first feed terminal 11 and second feed terminal 31. In the case in FIG. 18, feed terminals 11 and 31 are located on first main surface 41 of body 40.

First to third coil antennas 10C, 20, and 30 are arranged such that second coil antenna 20 is positioned farther from second main surface 42 than are first and third coil antennas 10C and 30. As for the arrangement of the first to third coil antennas, one opening surface 18A of first coil antenna 10C and one opening surface 38B of third coil antenna 30 can be seen from one opening surface 28B of second coil antenna without being blocked by the coil conductors of first to third coil antennas 10C, 20, and 30.

Preferably, when antenna device 6 is viewed two-dimensionally from the direction vertical to first main surface 41 of body 40, third coil antenna 30 is arranged on the opposite side to first coil antenna 10C with second coil antenna 20 interposed.

Preferably, the outer diameter and the inner diameter of the coil conductor of second coil antenna 20 are set greater than the outer shape and the inner diameter, respectively, of the coil conductor of first coil antenna 10C. In addition, the outer diameter and the inner diameter of the coil conductor of second coil antenna 20 preferably are set greater than the outer shape and the inner diameter, respectively, of the coil conductor of third coil antenna 30. Accordingly, a magnetic flux is introduced efficiently from first and third coil antennas 10C and 30 to second coil antenna 20.

A winding axis 63 of third coil antenna 30 intersects the two opposing side surfaces 43 of body 40 but does not intersect second main surface 42. In the case in FIG. 18 and FIG. 19, winding axis 63 of third coil antenna 30 is parallel or approximately parallel to first and second main surfaces 41 and 42. As shown in FIG. 19, it is desirable that winding axis 61 of first coil antenna 10C and winding axis 63 of third coil antenna should be parallel or approximately parallel to each other, ideally, common.

Second and third coil antennas 20 and 30 are wound in such a direction that when one of opening surface 28B of second coil antenna 20 and opening surface 38B of third coil antenna 30 that are opposed to each other serves as an entrance of magnetic flux, the other serves as an exit of magnetic flux. That is, in a case where current flows from one of second and third coil antennas 20 and 30 to the other, the winding direction of third coil antenna 30 is set such that the magnetic line of force passing through one opening surface 28B of second coil antenna 20 to the outside of second coil antenna 20 passes through one opening surface 38B of third coil antenna 30 to the inside of third coil antenna 30, or such that the magnetic line of force passing through one opening surface 38B of third coil antenna 30 to the outside of third coil antenna 30 passes through one opening surface 28B of second coil antenna 20 to the inside of second coil antenna 20. The setting of the winding direction of first and second coil antennas 10C and 20 is the same as in the first preferred embodiment. By setting the winding direction in this manner, first to third coil antennas 10C, 20, and 30 are magnetically coupled.

The order of electrical connection of first to third coil antennas 10C, 20, and 30 may be different from the case in FIG. 18 as long as first to third coil antennas 10C, 20, and 30 are electrically connected in series. For example, first coil antenna 10C, third coil antenna 30, and second coil antenna 20 may be connected in series in this order between first and second feed terminals 11 and 31. As another modification of the connection method, first to third coil antennas 10C, 20, and 30 may be connected in parallel with the feed circuit.

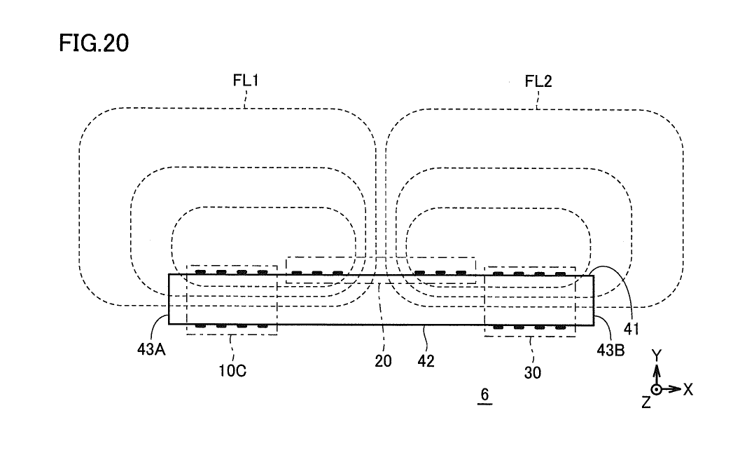

FIG. 20 is a diagram schematically showing a magnetic flux FL generated in antenna device 6. The configuration described with FIG. 18 and FIG. 19 produces a magnetic flux FL1 entering from side surface 43A of body 40, passing through the inside of first and second coil antennas 10C and 20, and exiting from first main surface 41, and a magnetic flux FL2 entering from side surface 43B of body 40, passing through the inside of third and second coil antennas 30 and 20, and exiting from first main surface 41. As a result, a region with high magnetic flux density is produced in the direction vertical to first main surface 41, and the communication distance is significantly increased in this vertical direction. Meanwhile, the magnetic flux density leaking from second main surface 42 is significantly reduced, so that second main surface 42 can be used as a surface affixed to a base material including metals.

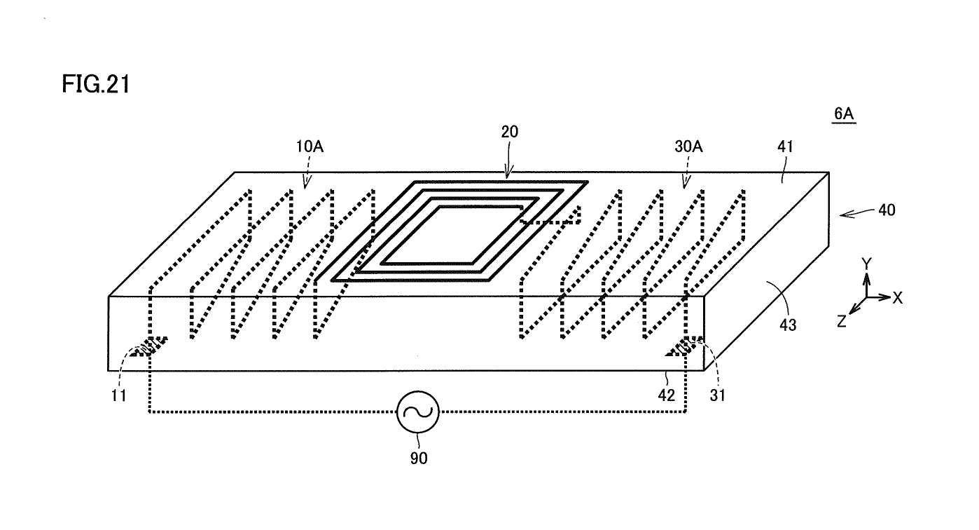

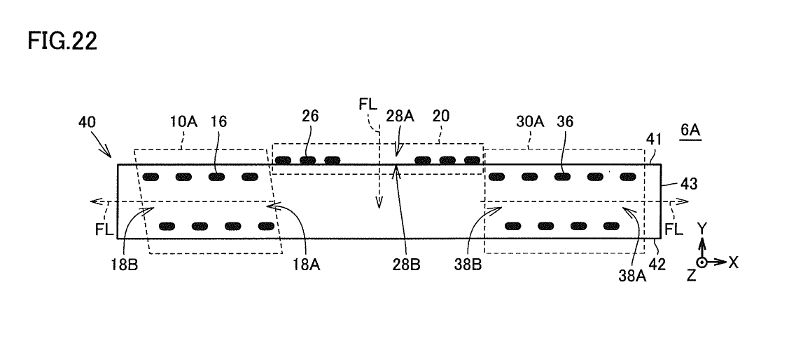

FIG. 21 is an external view schematically showing a configuration of an antenna device 6A as a modification of antenna device 6 in FIG. 18. FIG. 22 is a cross-sectional view showing antenna device 6A in FIG. 21 as viewed from the Z direction parallel to main surface 41.

Referring to FIG. 21 and FIG. 22, antenna device 6A differs from antenna device 6 described with FIG. 18 to FIG. 20 in that coil conductors 16 and 36 of first and third coil antennas 10A and 30A are provided inside body 40. In antenna device 6, the coil conductors of first and third coil antennas 10C and 30 are arranged to extend from the inside of body 40 to first and second main surfaces 41 and 42.

In the case of antenna device 6A, feed terminals 11 and 31 are provided not on first main surface 41 of body 40 but on second main surface 42. Feed terminal 11 is connected to an end portion of coil conductor 16 of first coil antenna 10A through a via hole provided inside body 40. Feed terminal 31 is connected to an end portion of coil conductor 36 of third coil antenna 30A through a via hole provided inside body 40. Feed circuit 90 is connected to feed terminals 11 and 31.

It is advantageous that second main surface 42 is a surface attached to a printed circuit board, in that feed terminals 11 and 31 can be connected with wiring provided on the printed circuit board by soldering. The other configuration of antenna device 6A in FIG. 21 and FIG. 22 is preferably the same or substantially the same as in antenna device 6 in FIG. 18 and FIG. 19. Therefore, the same or corresponding elements are denoted with the same reference signs and a detailed description thereof will not be repeated.

Antenna device 6A achieves the same operation effects as achieved by antenna device 6. Specifically, magnetic flux FL in the direction vertical to main surface 41 (the +Y direction) through second coil antenna 20 is significantly increased, and the communication distance in this direction of high magnetic flux density is significantly increased. On the other hand, the magnetic flux density leaking from second main surface 42 is significantly reduced, so that second main surface 42 can be used as a surface affixed to a base material including metals.

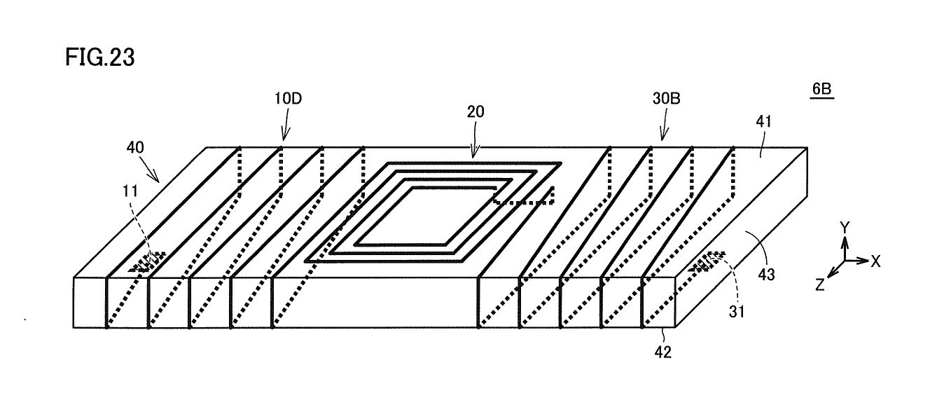

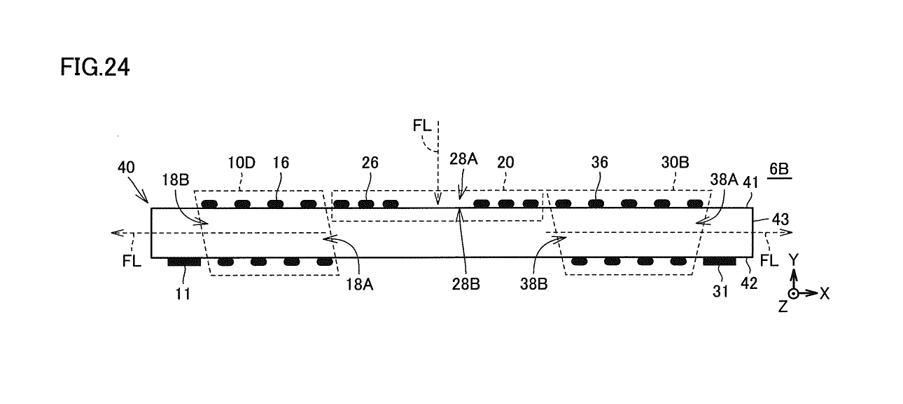

FIG. 23 is an external view schematically showing a configuration of an antenna device 6B as another modification of antenna device 6 in FIG. 18. FIG. 24 is a cross-sectional view showing antenna device 6B in FIG. 23 as viewed from the Z direction parallel to main surface 41.

Referring to FIG. 23 and FIG. 24, in the case of antenna device 6B, the coil conductors of first and third coil antennas 10D and 30B are located on the surface of body 40 (on first and second main surfaces 41 and 42 and on side surface 43). Furthermore, in the case of antenna device 6B, feed terminals 11 and 31 are provided not on first main surface 41 of body 40 but on second main surface 42. In these respects, antenna device 6B differs from antenna device 6 described with FIG. 18 and FIG. 19.

When body 40 is made of a ferromagnetic material, it is preferable that the coil conductors of all of coil antennas 10C, 20, and 30B are located on the surface of body 40 as shown in FIG. 23 and FIG. 24. The magnetic flux passes through the inside of the ferromagnetic material, thus coupling coil antennas 10C, 20, 30B more strongly. The other configuration and effects of antenna device 6B in FIG. 23 and FIG. 24 are preferably the same or substantially the same as in antenna device 6 in FIG. 18 and FIG. 19. Therefore, the same or corresponding elements are denoted with the same reference signs and a detailed description thereof will not be repeated.

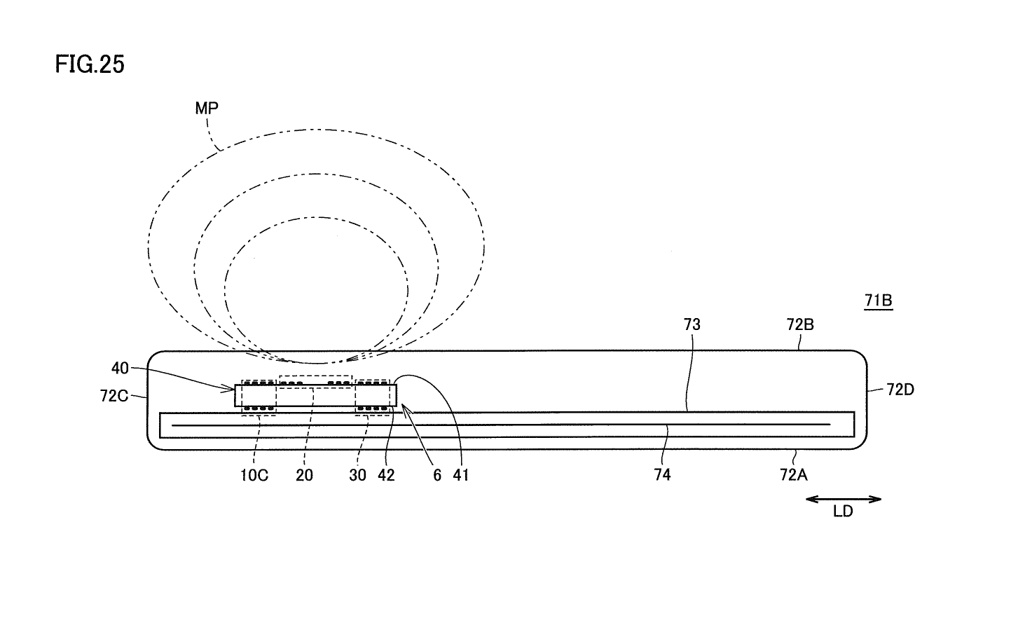

FIG. 25 is a diagram illustrating a specific arrangement of antenna device 6 when antenna device 6 shown in FIG. 18 is installed in a portable communication terminal 71B.

As shown in FIG. 25, first coil antenna 10 shown in FIG. 18 is arranged at a position proximate to front edge portion 72C of casing 72, and third coil antenna 30 is arranged on the opposite side to front edge portion 72C with first and second coil antennas 10 and 20 interposed. The winding axes of the first and third coil antennas 10 and 30 are parallel or approximately parallel to longitudinal direction LD of casing 72.

By arranging antenna device 6 as shown in FIG. 25, a region with high magnetic flux density is produced in a direction 90 degrees different from longitudinal direction LD of the terminal casing. In addition, a magnetic flux is less likely to leak on the second main surface 42 side of body 40. Therefore, an antenna device that is less susceptible to metals and achieves a sufficient communication distance is provided even though metals such as wiring and ground 74 are present on printed circuit board 73.

### Fourth Preferred Embodiment

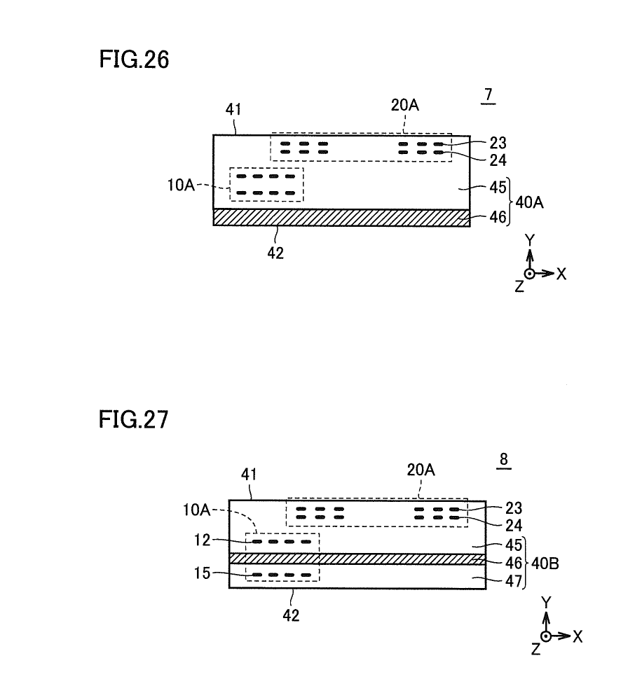

FIG. 26 is a cross-sectional view schematically showing a configuration of an antenna device 7 in a fourth preferred embodiment of the present invention. Antenna device 7 in FIG. 26 is a modification of antenna device 3 shown in FIG. 14.

Referring to FIG. 26, a body 40A includes a dielectric layer 45 and a magnetic material layer 46 of ferrite or the like. Magnetic material layer 46 is arranged between dielectric layer 45 and second main surface 42. The coil conductors of first and second coil antennas 10A and 20A are provided inside dielectric layer 45. First and second coil antennas 10A and 20A are arranged such that second coil antenna 20A is positioned farther from magnetic material layer 46 than the first coil antenna 10A. As described with FIG. 2, in general, dielectric layer 45 has a structure in which a plurality of substrate layers of dielectric are stacked in the Y direction (of course, dielectric layer 45 may be formed with one substrate layer). Similarly, magnetic material layer 46 may also have a structure in which a plurality of substrate layers of magnetic material are stacked in the Y direction (of course, magnetic material layer 46 may be formed with one substrate layer). Dielectric layer 45 may be a low-permeability magnetic material layer, and magnetic material layer 46 may be a high-permeability magnetic material layer having a permeability higher than dielectric layer 45.

In the configuration in FIG. 26, magnetic material layer 46 functions as a magnetic shielding layer, thus further reducing magnetic flux leaking to second main surface 42. The coil conductors of the first and second coil antennas may be provided not inside dielectric layer 45 but at least one of inside and on a surface of dielectric layer 45 (as for the coil conductor of the first coil antenna, including the interface between dielectric layer 45 and magnetic material layer 46).

### Fifth Preferred Embodiment

FIG. 27 is a cross-sectional view schematically showing a configuration of an antenna device 8 in a fifth preferred embodiment of the present invention. Antenna device 8 in FIG. 27 is a modification of antenna device 3 shown in FIG. 14.

Referring to FIG. 27, a body 40B preferably has a stack structure in which dielectric layer 45, magnetic material layer 46, and dielectric layer 47 are stacked in this order. Specifically, dielectric layer 47 is provided between dielectric layer 45 and second main surface 42, and magnetic material layer 46 is provided between dielectric layer 45 and dielectric layer 47. In general, dielectric layers 45 and 47 each have a structure in which a plurality of substrate layers of dielectric are stacked in the Y direction (of course, dielectric layers 45 and 47 each may be formed with one substrate layer). Similarly, magnetic material layer 46 may have a structure in which a plurality of substrate layers of magnetic material are stacked in the Y direction (of course, magnetic material layer 46 may be formed with one substrate layer). Dielectric layers 45 and 47 each may be a low-permeability magnetic material layer, and magnetic material layer 46 may be a high-permeability magnetic material layer having a permeability higher than dielectric layers 45 and 47.

The coil conductor of first coil antenna 10A includes a plurality of first conductor portions 12 located closer to first main surface 41 than magnetic material layer 46, a plurality of second conductor portions 15 located closer to second main surface 42 than magnetic material layer 46, and a plurality of third conductor portions (not shown) passing through magnetic material layer 46 to connect a plurality of first conductor portions 12 and a plurality of second conductor portions 15. The coil conductor of second coil antenna 20A is formed closer to first main surface 41 than magnetic material layer 46. In the configuration shown in FIG. 27, the magnetic flux can be concentrated inside magnetic material layer 46, so as to further increase the density of magnetic flux introduced to first and second coil antennas 10A and 20A.

The arrangement of first and second coil antennas is not limited to the arrangement shown in FIG. 27. More generally, the following arrangement can be employed. That is, the first coil antennas is provided so as to include a portion of magnetic material layer 46 in the inside thereof. A portion of the coil conductor of the first coil antenna is provided at least one of inside and on a surface of dielectric layer 45 (including the interface between dielectric layer 45 and magnetic material layer 46). The coil conductor of the second coil antenna is provided at least one of inside and on a surface of dielectric layer 45 (including the interface between dielectric layer 45 and magnetic material layer 46).

Magnetic material layer 46 may be arranged in the outermost layer including second main surface 42. In this case, the coil conductor of the first coil antenna includes a plurality of first conductor portions positioned farther from second main surface 42 than the magnetic material layer 46, a plurality of second conductor portions located on a surface of magnetic material layer 46 on the second main surface 42 side, and a plurality of third conductor portions passing through magnetic material layer 46 to connect a plurality of first conductor portions and a plurality of second conductor portions. Second coil antenna 20A is positioned farther from second main surface 42 than the magnetic material layer 46.

### Six Preferred Embodiment

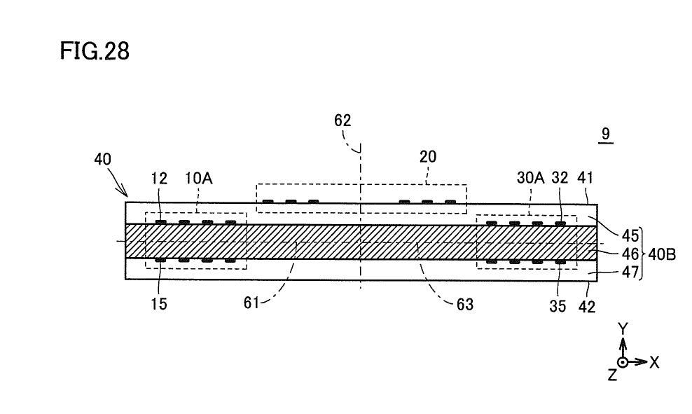

FIG. 28 is a cross-sectional view schematically showing a configuration of an antenna device 9 in a sixth preferred embodiment of the present invention. Antenna device 9 in FIG. 28 is a modification of antenna device 6A described with FIG. 21 and FIG. 22.

Referring to FIG. 28, body 40B preferably has a stack structure in which dielectric layer 45, magnetic material layer 46, and dielectric layer 47 are stacked in this order. That is, dielectric layer 47 is provided between dielectric layer 45 and second main surface 42, and magnetic material layer 46 is provided between dielectric layer 45 and dielectric layer 47. In general, dielectric layers 45 and 47 each have a structure in which a plurality of substrate layers of dielectric are stacked in the Y direction. Similarly, magnetic material layer 46 may have a structure in which a plurality of substrate layers of magnetic material are stacked in the Y direction. Dielectric layers 45 and 47 each may be a low-permeability magnetic material layer, and magnetic material layer 46 may be a high-permeability magnetic material layer having a permeability higher than dielectric layers 45 and 47.

The coil conductor of first coil antenna 10A includes a plurality of first conductor portions 12 located closer to first main surface 41 than magnetic material layer 46, a plurality of second conductor portions 15 located closer to second main surface 42 than magnetic material layer 46, and a plurality of third conductor portions (not shown) passing through magnetic material layer 46 to connect a plurality of first conductor portions 12 and a plurality of second conductor portions 15. In the case in FIG. 28, the conductor portions 12 and 15 are located on the surface of magnetic material layer 46.

The coil conductor of second coil antenna 20 is located closer to first main surface 41 than magnetic material layer 46. In the case in FIG. 28, second coil antenna 20 is located on first main surface 41.

The coil conductor of third coil antenna 30A includes a plurality of first conductor portions 32 located closer to first main surface 41 than magnetic material layer 46, a plurality of second conductor portions 35 located closer to second main surface 42 than magnetic material layer 46, and a plurality of third conductor portions (not shown) passing through magnetic material layer 46 to connect a plurality of first conductor portions 32 and a plurality of second conductor portions 35. In the case in FIG. 28, the conductor portions 32 and 35 are located on the surfaces of magnetic material layer 46.

The other respects in the arrangement of first to third coil antennas 10A to 30A, the direction in which the winding axis extends, and the winding direction around the winding axis of the coil conductor are preferably the same or substantially the same as in the third preferred embodiment. Therefore, a description thereof will not be repeated.

The arrangement of first to third coil antennas is not limited to the arrangement shown in FIG. 28. More generally, the following arrangement can be used. That is, the first and third coil antennas are each provided so as to include a portion of magnetic material layer 46 in the inside thereof. A portion of the coil conductor of each of the first and third coil antennas is provided at least one of inside and on a surface of dielectric layer 45 (including the interface between dielectric layer 45 and magnetic material layer 46). The coil conductor of the second coil antenna is provided at least one of inside and on a surface of dielectric layer 45 (including the interface between dielectric layer 45 and magnetic material layer 46).

In the configuration shown in FIG. 28, the magnetic flux can be concentrated inside magnetic material layer 46, thus further increasing the density of magnetic flux introduced to second coil antenna 20 and further reducing leakage of magnetic flux toward second main surface 42.

### Seventh Preferred Embodiment

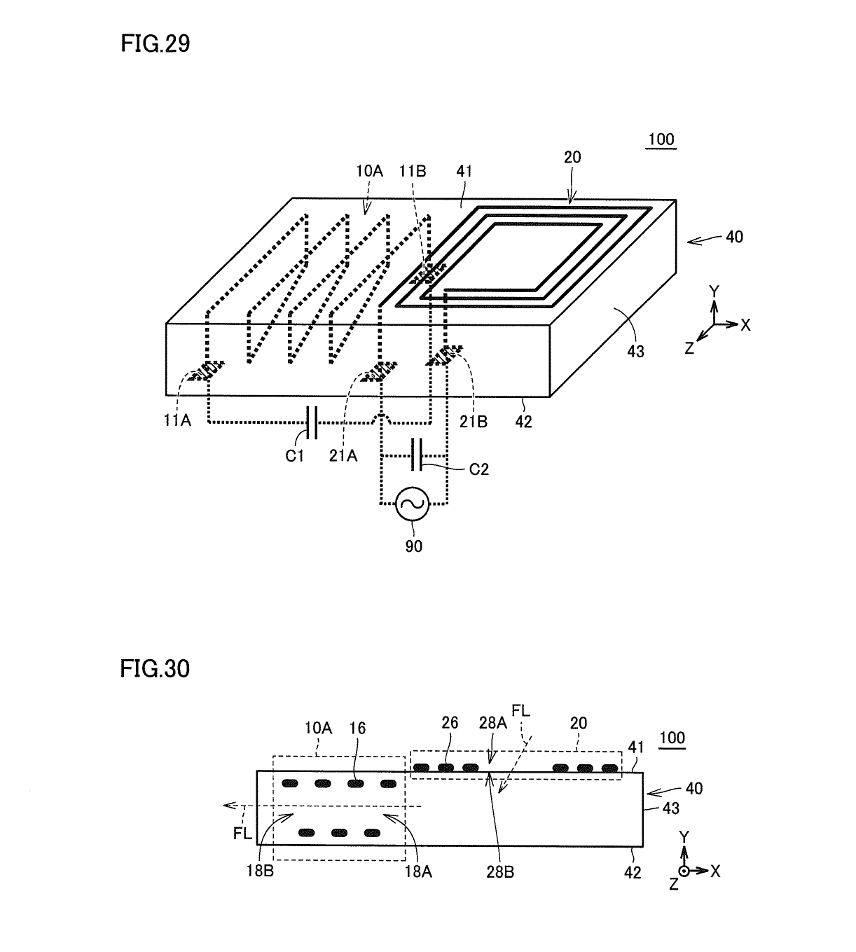

FIG. 29 is an external view schematically showing a configuration of an antenna device 100 in a seventh preferred embodiment of the present invention. FIG. 30 is a cross-sectional view showing antenna device 100 in FIG. 29 as viewed from the Z direction parallel to main surface 41.

Referring to FIG. 29 and FIG. 30, antenna device 100 is a modification of antenna device 1B described with FIG. 7 and FIG. 8 and differs from antenna device 1B in a power feeding method to antenna device 100. In the other respects, antenna device 100 is preferably the same or substantially the same as antenna device 1B. Therefore, the same or corresponding elements are denoted with the same reference signs and a detailed description thereof will not be repeated.

In antenna device 100, first coil antenna 10A is used as a non-feed element, and second coil antenna 20 is used as a feed element. That is, second coil antenna 20 is directly connected to feed circuit 90. First coil antenna 10A is not directly connected to feed circuit 90 but is magnetically coupled to second coil antenna 20 (magnetically coupled thereto using resonance) so as to receive magnetic field energy.

First and second coil antennas 10A and 20 each define a resonant circuit. As shown in FIG. 29, first coil antenna 10A defines a first resonant circuit with capacitance C1 between feed terminals 11A and 11B (this capacitance C1 includes parasitic capacitance of the coil conductor of coil antenna 10A). It is assumed that the resonance frequency of the first resonant circuit is f1. Second coil antenna 20 defines a second resonant circuit with capacitance C2 between feed terminals 21A and 21B (this capacitance C2 includes parasitic capacitance of the coil conductor of coil antenna 20 and parasitic capacitance of feed circuit 90). It is assumed that the resonance frequency of the second resonant circuit is f2.

Given that the carrier frequency for use in communication (the frequency of carrier wave of a transmission signal and/or a reception signal) is f0, resonance frequencies f1 and f2 are preferably set to values close to carrier frequency f0 and both greater than carrier frequency f0. Accordingly, the impedance between feed terminals 11A and 11B of first coil antenna 10A and the impedance between feed terminals 21A and 21B of second coil antenna 20 become inductive, so that first coil antenna 10A and second coil antenna 20 are magnetically coupled.

The frequency characteristics of electromagnetic field intensity emitted from antenna device 100 having the configuration above exhibit double-humped characteristic having two peaks, thus providing a broadband antenna. The other configuration and effects of antenna device 100 are preferably the same or substantially the same as in antenna device 1 described in the first preferred embodiment, and therefore a description will not be repeated.

Conversely to antenna device 100 as described above, first coil antenna 10A can be used as a feed element, and second coil antenna 20 can be used as a non-feed element.

### Eighth Preferred Embodiment

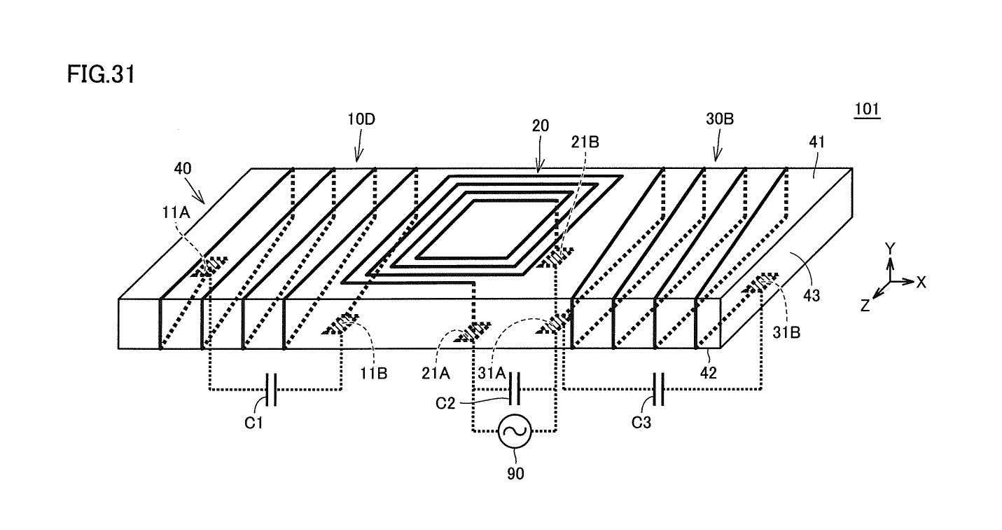

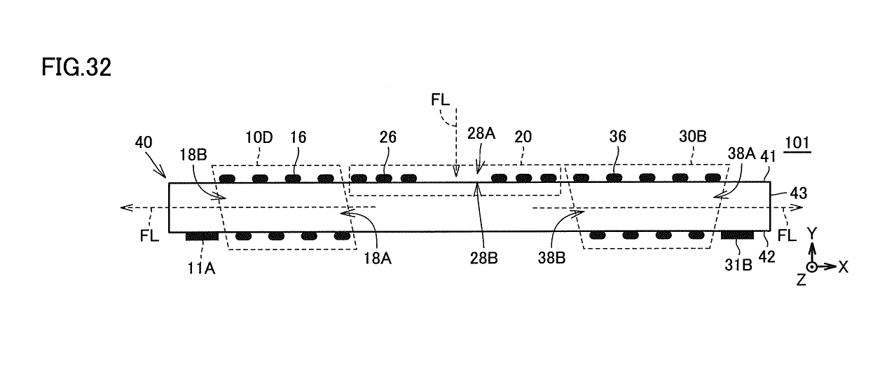

FIG. 31 is an external view schematically showing a configuration of an antenna device 101 in an eighth preferred embodiment of the present invention. FIG. 32 is a cross-sectional view showing antenna device 101 in FIG. 31 as viewed from the Z direction parallel to main surface 41.

Referring to FIG. 31 and FIG. 32, antenna device 101 is a modification of antenna device 6B described with FIG. 23 and FIG. 24. In antenna device 101, feed terminals 11A and 11B are connected to the opposite ends of coil conductor 16 that defines a first coil antenna 10D, feed terminals 21A and 21B are connected to the opposite ends of conductor 26 that defines second coil antenna 20, and feed terminals 31A and 31B are connected to the opposite ends of coil conductor 36 that defines a third coil antenna 30B. Feed terminals 11A, 11B, 21A, 21B, 31A, and 31B are provided on second main surface 42 of body 40. Wiring to connect first to third coil antennas 10D, 20, and 30B in series is not provided in body 40.

The power feeding method to antenna device 101 differs from that of antenna device 6B. Specifically, in antenna device 101, first and third coil antennas 10D and 30B are used as non-feed elements, and second coil antenna 20 is used as a feed element. That is, second coil antenna 20 is directly connected to feed circuit 90. First and third coil antennas 10D and 30B are not directly connected to feed circuit 90 but magnetically coupled to second coil antenna 20 so as to receive magnetic field energy.

First to third coil antennas 10D, 20, and 30B each define a resonant circuit. As shown in FIG. 31, first coil antenna 10D defines a first resonant circuit with capacitance C1 between feed terminals 11A and 11B. It is assumed that the resonance frequency of the first resonant circuit is f1. Second coil antenna 20 defines a second resonant circuit with capacitance C2 between feed terminals 21A and 21B. It is assumed that the resonance frequency of the second resonant circuit is f2. Third coil antenna 30 defines a third resonant circuit with capacitance C3 between feed terminals 31A and 31B. It is assumed that the resonance frequency of the third resonant circuit is f3. These capacitances C1, C2, and C3 include parasitic capacitance.

Given that the carrier frequency for use in communication (the frequency of carrier wave of a transmission signal and/or a reception signal) is f0, resonance frequencies f1, f2, and f3 are preferably set to values close to carrier frequency f0 and all greater than carrier frequency f0. Accordingly, the impedance between feed terminals 11A and 11B of first coil antenna 10D, the impedance between feed terminals 21A and 21B of second coil antenna 20, and the impedance between feed terminals 31A and 31B of third coil antenna 30B become inductive, so that first and third coil antennas 10D and 30B and second coil antenna 20 are magnetically coupled.

The frequency characteristics of emission intensity from antenna device 101 having the configuration above exhibit triple-humped characteristic having three peaks, thus providing a broadband antenna. The other configuration and effects of antenna device 101 are preferably the same or substantially the same as in antenna device 6 described in the third preferred embodiment, and therefore a description will not be repeated.

Unlike antenna device 101 as described above, one of the first and third coil antennas 10D and 30B may be used as a feed element, and the other coil antennas may be used as non-feed elements. However, in view of emission intensity, it is preferable to use second coil antenna 20 as a feed element. Two of first to third coil antennas 10D, 20, and 30B may be used as feed elements, and the rest of them may be used as a non-feed element.

### Ninth Preferred Embodiment

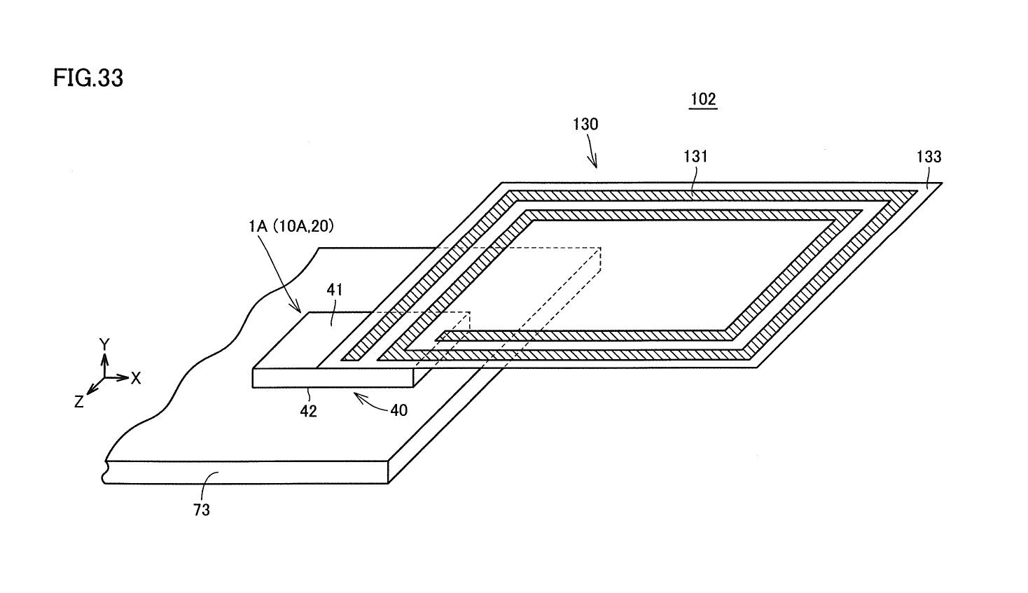

FIG. 33 is an external view schematically showing a configuration of an antenna device 102 in a ninth preferred embodiment of the present invention.

Referring to FIG. 33, antenna device 102 in the ninth preferred embodiment further includes a coil-type booster antenna (booster coil) 130 in addition to the configuration of any one of antenna devices in the first to eighth preferred embodiments described above. Booster antenna 130 is arranged in the vicinity of a plurality of coil antennas provided in body 40 so as to be magnetically coupled to these coil antennas. The outer shape of booster antenna 130 is greater than the outer diameter of each coil antenna formed in body 40.

In the following, an example in which booster antenna 130 is further added to antenna device 1A described with FIG. 5 and FIG. 6 will be described as a representative example. As shown in FIG. 33, in antenna device 1A, second main surface 42 is a surface attached to printed circuit board 73. A plurality of coil antennas 10A and 20 provided in body 40 are connected to a feed circuit installed in printed circuit board 73. Antenna device 1A communicates with a coil antenna on the other side through booster antenna 130.

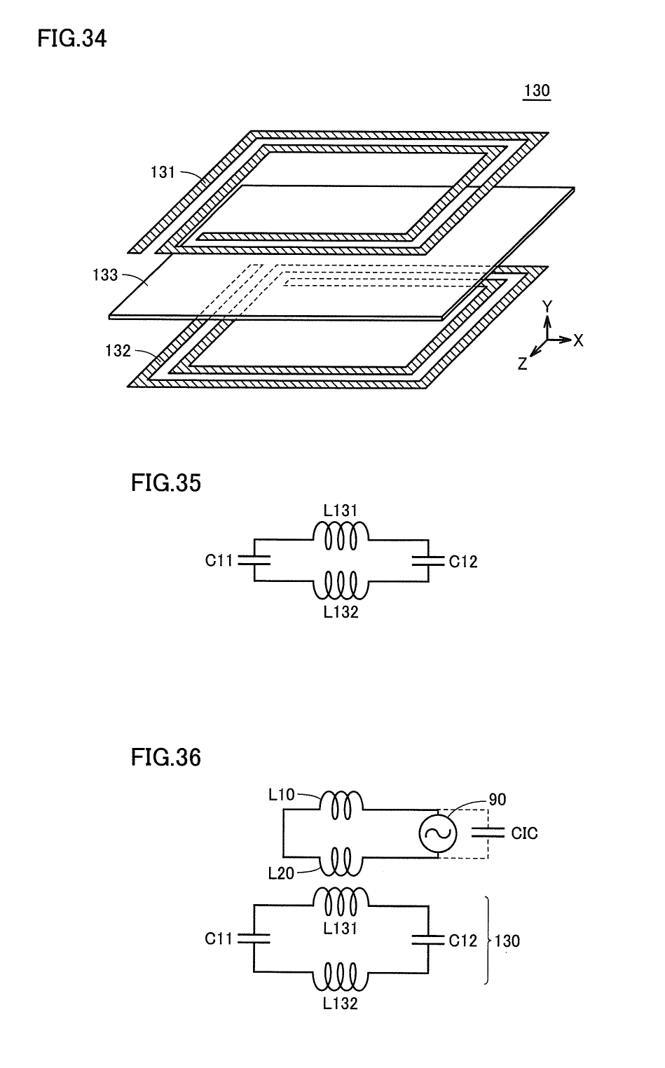

FIG. 34 is an exploded perspective view schematically showing a configuration of booster antenna 130 in FIG. 33. Referring to FIG. 34, booster antenna 130 includes a substrate sheet 133, a first coil conductor 131 located on a first main surface (on the main surface in the +Y direction) of substrate sheet 133, and second coil conductor 132 located on a second main surface (on the main surface in the −Y direction) of substrate sheet 133. Coil conductors 131 and 132 preferably are patterned to define a rectangular or substantially rectangular spiral. When viewed from the first main surface (from the +Y direction), first coil conductor 131 and second coil conductor 132 are arranged such that most of the patterns overlap each other although the winding directions are opposite. In other words, the winding direction of first coil conductor 131 as viewed from the first main surface (from the +Y direction) and the winding direction of second coil conductor 132 as viewed from the second main surface (from the −Y direction) are the same. First coil conductor 131 and second coil conductor 132 are electromagnetically coupled (capacitive coupling and inductive coupling).

FIG. 35 is an equivalent circuit diagram of booster antenna 130 in FIG. 34. Referring to FIG. 35, the inductance of first coil conductor 131 in FIG. 34 is represented by inductor L131, and the inductance of second coil conductor 132 is represented by inductor L132. The capacitance produced between first and second coil conductors 131 and 132 in FIG. 34 is represented as a lumped constant element by capacitors C11 and C12.

The two coil conductors 131 and 132 of booster antenna 130 are wound and arranged such that induced currents flowing through coil conductors 131 and 132 propagate in the same direction, and are coupled to each other through capacitance. In booster antenna 130, therefore, the inductance of each conductor 131 and 132 and the capacitance generated by capacitive coupling between coil inductors 131 and 132 configure the first resonant circuit. The resonance frequency of the first resonant circuit is preferably substantially equivalent to the carrier frequency for use in communication (the resonance frequency is slightly greater than the carrier frequency). This increases the communication distance.

FIG. 36 is an equivalent circuit diagram of antenna device 102 in FIG. 33. In the equivalent circuit in FIG. 36, the equivalent circuit of antenna device 1A in FIG. 5 is added to the equivalent circuit of the booster antenna in FIG. 35.

Referring to FIG. 36, the inductance of first coil antenna 10A in FIG. 5 is represented by inductor L10, and the inductance of first coil antenna 20 in FIG. 5 is represented by inductor L20. A capacitor CIC in FIG. 36 represents the capacitance between feed terminals 11 and 21 in FIG. 5. This capacitance includes parasitic capacitance of an RFIC (Radio Frequency Integrated Circuit).

Inductors L10 and L20 and capacitor CIC define the second resonant circuit. The frequency of the second resonant circuit is substantially equivalent to the carrier frequency for use in communication (the resonance frequency is slightly greater than the carrier frequency). Furthermore, inductor L20 and inductors L131 and L132 are magnetically coupled. Therefore, feed circuit 90 (radio frequency integrated circuit) is coupled to the first resonant circuit as described above defined by booster antenna 130 in an impedance matching state. In this manner, feed circuit 90 is strongly magnetically coupled to booster antenna 130 with coil antennas 10A and 20 interposed. Accordingly, mechanical connection elements such as a contact pin or a flexible cable is not required for connection between feed circuit 90 and booster antenna 130.

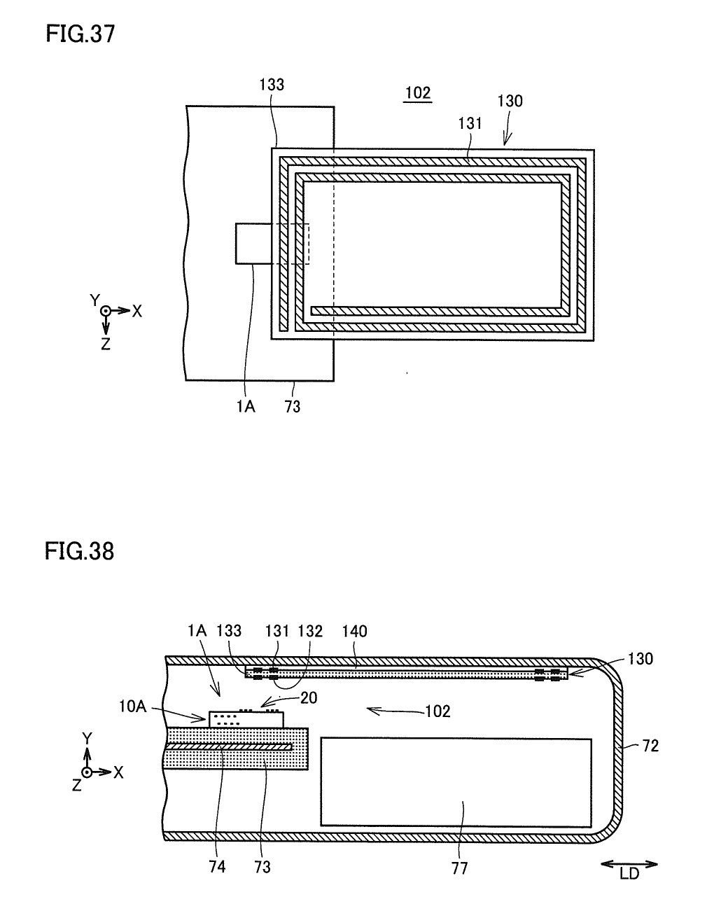

FIG. 37 is a plan view of antenna device 102. FIG. 38 is a cross-sectional view of a communication terminal apparatus with antenna device 102.

Referring to FIG. 37 and FIG. 38, antenna device 1A (coil antennas 10A and 20) is installed in printed circuit board provided inside casing 72 as a surface mount component. Inside printed circuit board 73, ground layer 74 is provided. Booster antenna 130 is affixed to an inner wall of casing 72 with adhesive 140.

Booster antenna 130 is arranged at an end portion in longitudinal direction LD of casing 72 because it is preferably brought close to an antenna on the other side of communication. Coil antennas 10A and 20 are arranged at a position closer to the center in longitudinal direction LD of casing 72 than booster antenna 130. Specifically, when viewed two-dimensionally from the Y direction in FIG. 38 (from the winding axis direction of booster antenna 130), coil antenna 20 is preferably arranged so as to overlap a portion of coil conductors 131 and 132 of booster antenna 130. Coil antenna 10A is preferably arranged on the opposite side to booster antenna 130 with coil antenna 20 interposed.

With such an arrangement, most of the magnetic flux passing through the inside of coil antenna 20 passes through the inside of booster antenna 130, so that coil antenna 20 and booster antenna 130 are strongly coupled. With this configuration, in FIG. 38, it is not necessary to provide printed circuit board 73 in a region below booster antenna 130, thus allowing, for example, a battery pack 77 to be arranged in this region.

### Tenth Preferred Embodiment

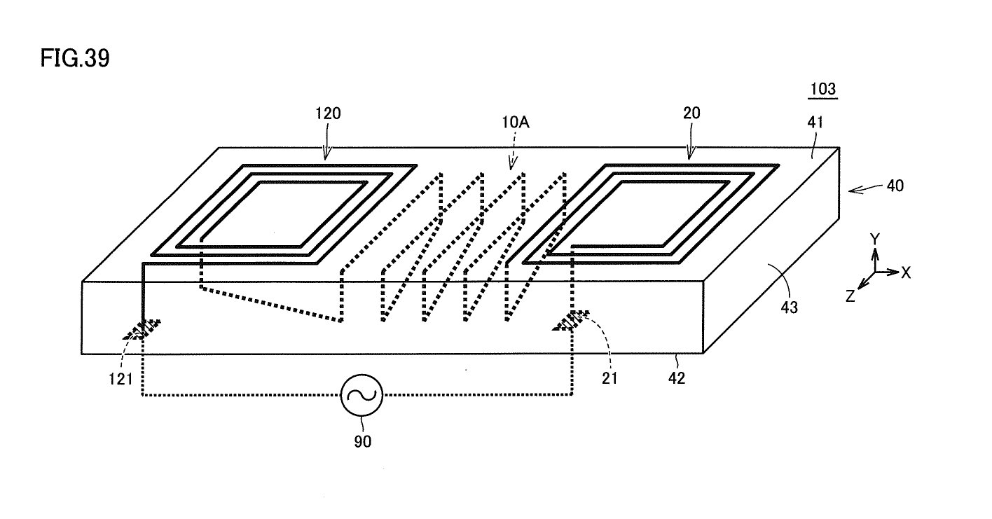

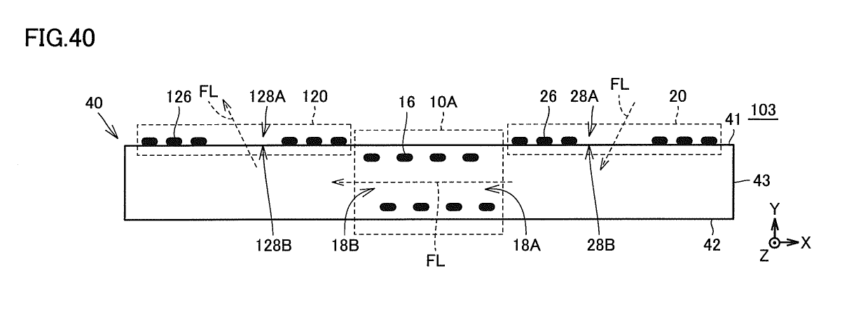

FIG. 39 is an external view schematically showing a configuration of an antenna device 103 in a tenth preferred embodiment of the present invention. FIG. 40 is a cross-sectional view showing antenna device 103 in FIG. 39 as viewed from the Z direction parallel to main surface 41.

Referring to FIG. 39 and FIG. 40, antenna device 103 is preferably provided by further adding a third coil antenna 120 to first and second coil antennas 10A and 20 that define antenna device 1A described with FIG. 5 and FIG. 6.

The direction of the winding axis of third coil antenna 120 intersects first and second main surfaces 41 and 42 of body 40. When viewed two-dimensionally from the direction vertical to first main surface 41, third coil antenna 120 is arranged on the opposite side to second coil antenna 20 with first coil antenna 10A interposed. Furthermore, first to third coil antennas 10A, 20, and 120 are arranged such that second and third coil antennas 20 and 120 are positioned farther from second main surface 42 is than first coil antenna 10A.

In a more preferred arrangement, one opening surface 28B of second coil antenna 20 can be seen from one opening surface 18A of first coil antenna 10A without being blocked by coil conductors 16 and 26 of first and second coil antennas 10A and 20. One opening surface 128B of third coil antenna 120 can be seen from the other opening surface 18B of first coil antenna 10A without being blocked by coil conductors 16 and 126 of first and third coil antennas 10A and 120.

Further preferably, the outer diameter and the inner diameter of coil conductor 26 of second coil antenna 20 are preferably greater than the outer diameter and the inner diameter, respectively, of coil conductor 16 of first coil antenna 10A. The outer diameter and the inner diameter of coil conductor 126 of third coil antenna 120 are preferably greater than the outer diameter and the inner diameter, respectively, of coil conductor 16 of first coil antenna 10A. Accordingly, a magnetic flux is efficiently introduced from first coil antenna 10A to second and third coil antennas 20 and 120.

In the case of the example in FIG. 39, third coil antenna 120 preferably is a planar antenna in which a coil conductor is provided on first main surface 41 of body 40. However, third coil antenna 120 is not limited to a planar antenna. More generally, the coil conductor of third coil antenna 120 is provided at least one of inside and on a surface of body 40 so as to satisfy the arrangement conditions as described above.

Antenna device 103 further includes feed terminals 21 and 121 provided on second main surface 42 of body 40. Second coil antenna 20, first coil antenna 10A, and third coil antenna 120 are connected in series in this order between feed terminals 21 and 121. Feed circuit 90 is connected between feed terminals 21 and 121.

The winding direction of coil antennas 10A, 20, and 121 preferably satisfies the following conditions. Namely, as shown by magnetic flux FL in FIG. 40, first and second coil antennas 10A and 20 are wound in such a direction that when one of opening surface 18A of first coil antenna 10A and opening surface 28B of second coil antenna 20 that are opposed to each other serves as an entrance of magnetic flux, the other serves as an exit of magnetic flux. First and third coil antennas 10A and 120 are wound in such a direction that when one of opening surface 18B of first coil antenna 10A and opening surface 128B of third coil antenna 120 that are opposed to each other serves as an entrance of magnetic flux, the other serves as an exit of magnetic flux. With the winding direction set in such a manner, first to third coil antennas 10A, 20, and 120 are magnetically coupled.

In the configuration as described above, the magnetic flux density obliquely upward from second coil antenna 20 (the direction between the +X direction and the +Y direction in FIG. 40) is increased, and the communication distance in the direction of high magnetic flux density is increased. Similarly, the magnetic flux density obliquely upward from third coil antenna 120 (the direction between the −X direction and the +Y direction in FIG. 40) is increased, and the communication distance in the direction of high magnetic flux density is increased. On the other hand, the magnetic flux density leaking from second main surface 42 is reduced, so that second main surface 42 can be used as a surface affixed to a base material including metals.

### Eleventh Preferred Embodiment

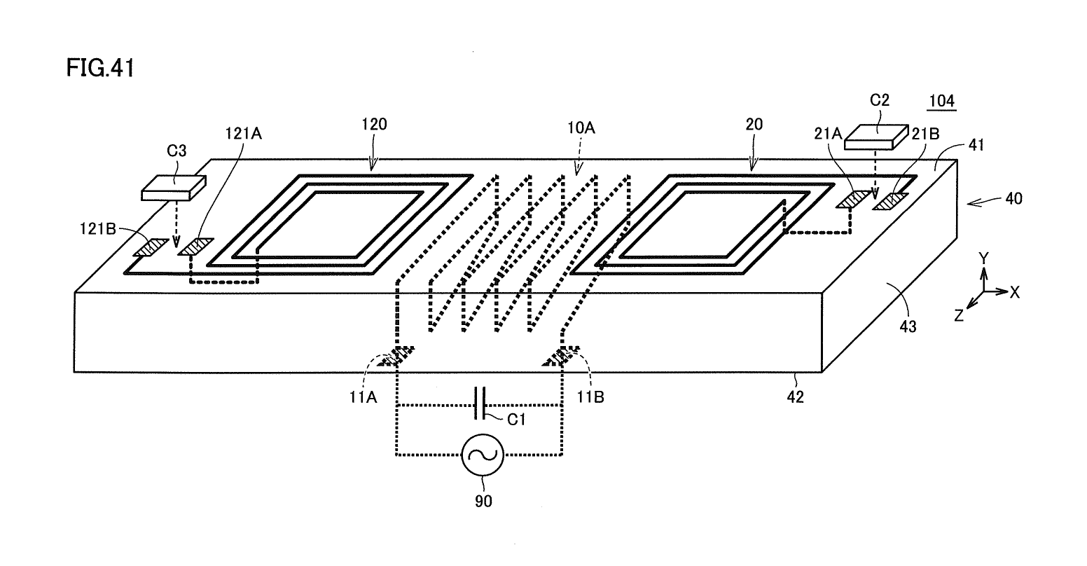

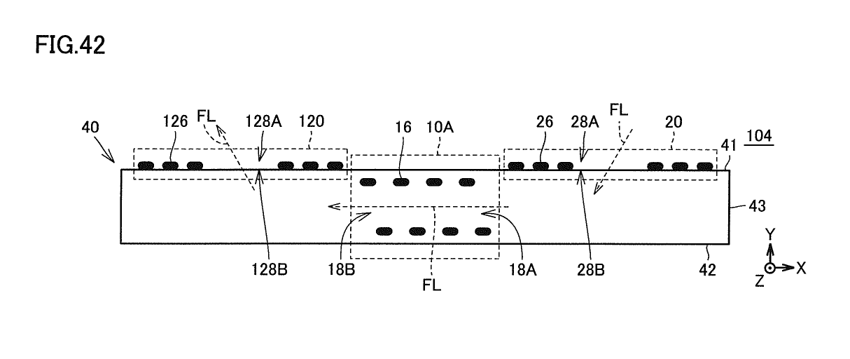

FIG. 41 is an external view schematically showing a configuration of an antenna device 104 in an eleventh preferred embodiment of the present invention. FIG. 42 is a cross-sectional view showing antenna device 104 in FIG. 41 as viewed from the Z direction parallel to main surface 41.

Referring to FIG. 41 and FIG. 42, antenna device 104 is a modification of antenna device 103 described with FIG. 39 and FIG. 40. Specifically, antenna device 104 differs from antenna device 103 in that coil antennas 10A, 20, and 120 are not connected in series. That is, in the case of antenna device 104, feed terminals 11A and 11B are connected to the opposite ends of coil conductor 16 that defines first coil antenna 10A. Feed terminals 11A and 11B are provided on second main surface 42. Feed terminals 21A and 21B are connected to the opposite ends of coil conductor 20 that defines second coil antenna 20. Feed terminals 21A and 21B are provided in proximity to each other on first main surface 41. Feed terminals 121A and 121B are provided at the opposite ends of coil conductor 126 that defines third coil antenna 120. Feed terminals 121A and 121B are provided in proximity to each other on first main surface 41.

Furthermore, the power feeding method to antenna device 104 differs from that of antenna device 103. In antenna device 104, second and third coil antennas 20 and 120 are used as non-feed elements, and first coil antenna 10A is used as a feed element. That is, first coil antenna 10A is directly connected to feed circuit 90 through feed terminals 11A and 11B. Second and third coil antennas 20 and 120 are not directly connected to feed circuit 90 but magnetically coupled to the first coil antenna so as to receive magnetic field energy.

First to third coil antennas 10A, 20, and 120 each define a resonant circuit. Specifically, first coil antenna 10A defines a first resonant circuit with capacitance C1 between feed terminals 11A and 11B (this capacitance C1 includes parasitic capacitance of the coil conductor of coil antenna 10A and parasitic capacitance of feed circuit 90). It is assumed that the resonance frequency of the first resonant circuit is f1. Capacitor C2 is attached to feed terminals 21A and 21B connected to the opposite ends of coil conductor 26 of second coil antenna 20. Capacitor C2 and coil antenna 20 define a second resonant circuit. It is assumed that the resonance frequency of the second resonant circuit is f2. Capacitor C3 is attached to feed terminals 121A and 121B connected to the opposite ends of coil conductor 126 of third coil antenna 120. Capacitor C3 and coil antenna 120 define a third resonant circuit. It is assumed that the resonance frequency of the third resonant circuit is f3.

Given that the carrier frequency for use in communication (the frequency of carrier wave of a transmission signal and/or a reception signal) is f0, resonance frequencies f1, f2, and f3 have to be set to values close to carrier frequency f0 and all greater than carrier frequency f0. Accordingly, the impedance between feed terminals 11A and 11B of first coil antenna 10A, the impedance between feed terminals 21A and 21B of second coil antenna 20, and the impedance between feed terminals 121A and 121B of third coil antenna 120 become inductive, so that first to third coil antennas 10A, 20, and 120 are magnetically coupled to each other.

The frequency characteristics of emission intensity from antenna device 104 having the configuration above exhibit triple-humped characteristic having three peaks, thus achieving a broadband antenna. The other configuration and effects of antenna device 104 are preferably the same or substantially the same as in antenna device 103 described in the tenth preferred embodiment, and therefore a description will not be repeated.

Unlike antenna device 104 as described above, one of second and third antennas 20 and 120 may be used as a feed element and the other coil antenna may be used as a non-feed element. However, in view of emission intensity, it is preferable to use second coil antenna 20 as a feed element. Two of first to third coil antennas 10A, 20, and 120 may be used as feed elements, and the rest of them may be used as a non-feed element.

### Twelfth Preferred Embodiment

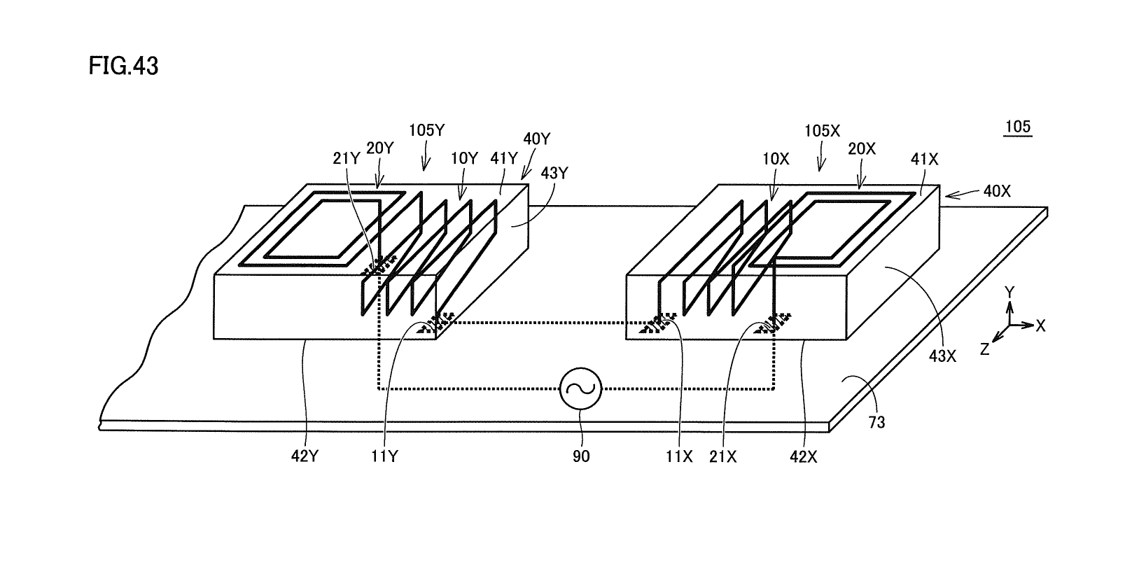

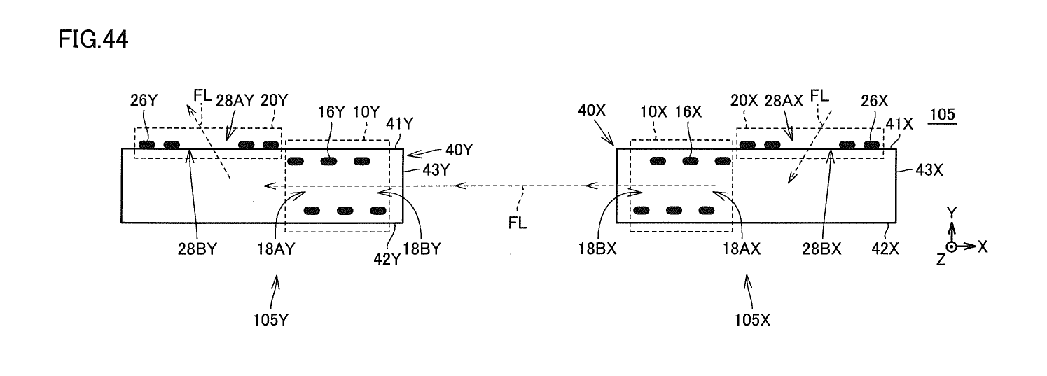

FIG. 43 is an external view schematically showing a configuration of an antenna device 105 in a twelfth preferred embodiment of the present invention. FIG. 44 is a cross-sectional view showing antenna device 105 in FIG. 43 as viewed from the Z direction parallel to substrate 73.

Referring to FIG. 43 and FIG. 44, antenna device 105 includes two antenna chips 105X and 105Y attached to a common substrate (printed circuit board) 73.

Antenna chip 105X includes a body 40X, a first coil antenna 10X, a second coil antenna 20X, and feed terminals 11X and 21X. Their configuration is preferably the same or substantially the same as in antenna device 1A described with FIG. 5 and FIG. 6, and therefore a description thereof will not be repeated. A second main surface 42X of body 40X is a surface attached to printed circuit board 73. When second main surface 42X is a surface attached to the printed circuit board, coil antennas 10X and 20X are arranged such that coil antenna 20X is positioned farther from second main surface 42X than the coil antenna 10X.

Similarly, antenna chip 105Y includes a body 40Y, a first coil antenna 10Y, a second coil antenna 20Y, and feed terminals 11Y and 21Y. Their configuration is preferably the same or substantially the same as in antenna device 1A described with FIG. 5 and FIG. 6. In the case in FIG. 43, the winding direction of coil antenna 10Y is preferably the same or substantially the same as the winding direction of coil antenna 10X, and the winding direction of coil antenna 20Y preferably is the same or substantially the same as the winding direction of coil antenna 20X. A second main surface 42Y of body 40Y is a surface affixed to printed circuit board 73. When second main surface 42Y is a surface attached to the printed circuit board, coil antennas 10Y and 20Y are arranged such that coil antenna 20Y is positioned farther from second main surface 42Y than the coil antenna 10Y.

When viewed two-dimensionally from the direction vertical to printed circuit board 73, coil antennas 20X and 20Y are arranged on the opposite sides to each other with coil antennas 10X and 10Y interposed. The direction of the winding axis of coil antenna 10X is parallel or approximately parallel to the direction of the winding axis of coil antenna 10Y.

Feed terminals 11X and 11Y are connected with each other by wiring provided in printed circuit board 73. Feed terminals 21X and 21Y are connected to feed circuit 90 installed in printed circuit board 73. In this case, a magnetic flux is produced in the direction shown by magnetic flux FL in FIG. 44. That is, when one of an opening surface 18BX of coil antenna 10X and an opening surface 18BY of coil antenna 10Y that are opposed to each other serves as an entrance of magnetic flux, the other serves as an exit of magnetic flux. When one of an opening surface 18AX of coil antenna 10X and an opening surface 28BX of coil antenna 20X that are opposed to each other serves as an entrance of magnetic flux, the other serves as an exit of magnetic flux. When one of an opening surface 18AY of coil antenna 10Y and an opening surface 28BY of coil antenna 20Y that are opposed to each other serves as an entrance of magnetic flux, the other serves as an exit of magnetic flux.

In antenna device 105 having the configuration as described above, the magnetic flux density obliquely upward from coil antenna 20X (the direction between the +X direction and the +Y direction in FIG. 44) is increased, and the communication distance in the direction of high magnetic flux density is increased. Similarly, the magnetic flux density obliquely upward from coil antenna 20Y (the direction between the −X direction and the +Y direction in FIG. 44) is increased, and the communication distance in the direction of high magnetic flux density is increased. Meanwhile, the magnetic flux density leaking from second main surface 42X of body 40X and second main surface 42Y of body 40Y is reduced, so that second main surface 42X of body 40X and second main surface 42Y of body 40Y can be used as surfaces affixed to a base material including metals.

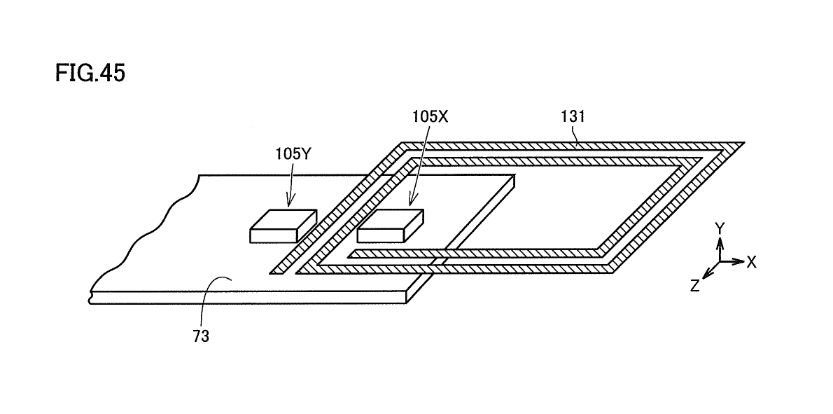

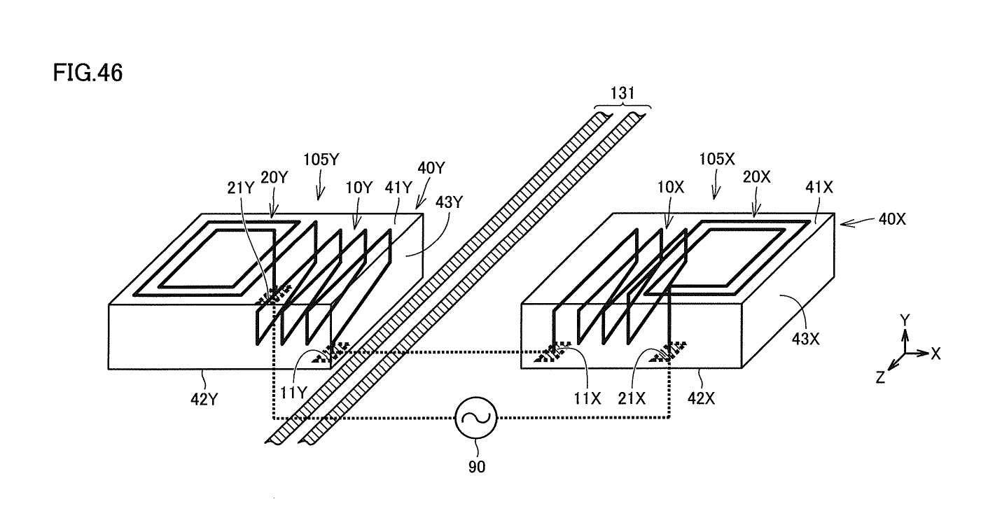

FIG. 45 is a diagram showing a configuration in which booster antenna 130 shown in FIG. 34 is added to antenna device 105 in FIG. 43. FIG. 46 is a partially enlarged view of FIG. 45. In FIG. 45 and FIG. 46, only the first coil conductor 131 of booster antenna 130 in FIG. 34 is shown for the sake of brevity.

Referring to FIG. 45 and FIG. 46, the opening surface of coil conductor 131 that defines a booster antenna is arranged obliquely upward of printed circuit board 73 and parallel or approximately parallel to printed circuit board 73. As viewed two-dimensionally from the direction vertical to printed circuit board 73, coil conductor 131 is arranged so as to partially pass through between an antenna chip 105X and an antenna chip 105Y. That is, antenna chip 105X is arranged on the inner side of coil conductor 131, and antenna chip 105Y is arranged on the outer side of coil conductor 131.

With such a configuration, most of the magnetic flux passing through the inside of coil antenna 20X passes through the inside of booster antenna 130, so that coil antenna 20X and booster antenna 130 can be strongly coupled. With this configuration, it is not necessary to provide printed circuit board 73 in the entire region below booster antenna 130, thus allowing, for example, a battery pack to be arranged in this region.

Antenna device 105 having a similar configuration as antenna device 103 described in the tenth preferred embodiment is advantageous in that the chip size can be reduced when compared with antenna device 103, thus reducing the production cost.

### Thirteenth Preferred Embodiment

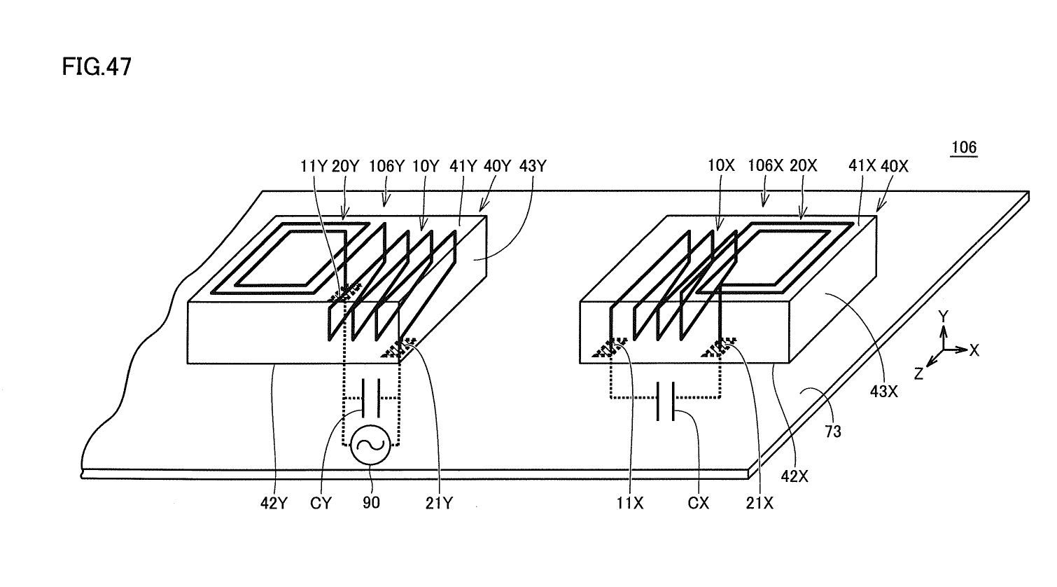

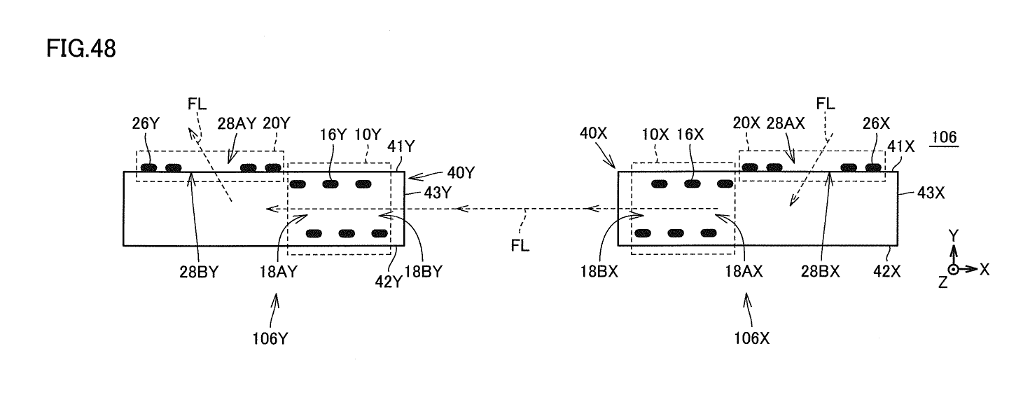

FIG. 47 is an external view schematically showing a configuration of an antenna device 106 in a thirteenth preferred embodiment of the present invention. FIG. 48 is a cross-sectional view showing antenna device 106 in FIG. 47 as viewed from the Z direction parallel to substrate 73.

Referring to FIG. 47 and FIG. 48, antenna device 106 is a modification of antenna device 105 described with FIG. 43 to FIG. 46 and differs from antenna device 105 in the power feeding method to antenna device 106. In the other respects, antenna device 106 preferably is the same or substantially the same as antenna device 105. Therefore, the same or corresponding elements are denoted with the same reference signs and a detailed description thereof will not be repeated.

In antenna device 106, an antenna chip 106X (corresponding to antenna chip 105X) is used as a non-feed element, and an antenna chip 106Y (corresponding to antenna chip 105Y) is used as a feed element. That is, feed circuit 90 is directly connected between feed terminals 11Y and 21Y of antenna chip 106Y. Coil antennas 10X and 20X of antenna chip 106X are not directly connected to feed circuit 90 but magnetically coupled to coil antennas 10Y and 20Y of antenna chip 106Y thereby to receive magnetic field energy.

As shown in FIG. 47, coil antennas 10X and 20X of antenna chip 106X define a first resonant circuit with capacitance CX between feed terminal 11X and 21X (this capacitance CX includes parasitic capacitance of coil antennas 10X and 20X). It is assumed that the resonance frequency of the first resonant circuit is f1. Coil antennas 10Y and 20Y of antenna chip 106Y define a second resonant circuit with capacitance CY between feed terminal 11Y and 21Y (this capacitance CY includes parasitic capacitance of coil antennas 10Y and 20Y and parasitic capacitance of feed circuit 90). It is assumed that the resonance frequency of the second resonant circuit is f2.

Given that the carrier frequency for use in communication (the frequency of carrier wave of a transmission signal and/or a reception signal) is f0, resonance frequencies f1 and f2 are preferably set to values close to carrier frequency f0 and both greater than carrier frequency f0. Accordingly, the impedance between feed terminals 11X and 21X of antenna chip 106X and the impedance between feed terminals 11Y and 21Y of antenna chip 106Y become inductive, so that coil antennas 10X and 20X of antenna chip 106X and coil antennas 10Y and 20Y of antenna chip 106Y are magnetically coupled.

The frequency characteristics of electromagnetic field intensity emitted from antenna device 106 having the configuration above exhibit double-humped characteristic having two peaks, thus achieving a broadband antenna. The other configuration and effects of antenna device 106 are preferably the same or substantially the same as in antenna device 105 described in the twelfth preferred embodiment, and therefore a description will not be repeated.

Conversely to antenna device 106 as described above, antenna chip 106X may be used as a feed element, and antenna chip 106Y may be used as a non-feed element.

It should be noted that the preferred embodiments disclosed herein are illustrated by way of example in all respects but not by way of limitation. For example, the antenna device in each preferred embodiment above is not limited to an antenna for use in HF-band RFID systems such as Felica and NFC but is applicable to antennas for various frequency bands, for example, such as an FM radio antenna or an antenna in a keyless entry module.

The scope of the present invention is shown not in the foregoing description but in the claims, and it is intended that all modifications that come within the meaning and range of equivalence to the claims are embraced here.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. (canceled)

2. An antenna device comprising:
a body including first and second main surfaces opposed to each other and one or more side surfaces connected to the first and second main surfaces;
a first coil antenna including a coil conductor provided at least one of inside and on a surface of the body, and including a winding axis intersecting at least one of the one or more side surfaces;
a second coil antenna including a coil conductor provided at least one of inside and on a surface of the body, and including a winding axis intersecting the first and second main surfaces; and
a conductor layer opposed to the second main surface; wherein
the first and second coil antennas are arranged such that the second coil antenna is positioned farther from the second main surface than the first coil antenna.

3. The antenna device according to claim 2, wherein the first and second coil antennas are arranged such that one opening surface of the second coil antenna is visible from one opening surface of the first coil antenna without being blocked by the coil conductors of the first and second coil antennas.

4. The antenna device according to claim 3, wherein
the first and second coil antennas are connected in series or in parallel with an external feed circuit and are magnetically coupled to each other; and
the first and second coil antennas are wound in such a direction that when the one opening surface of the first coil antenna serves as an entrance of magnetic flux, the one opening surface of the second coil antenna serves as an exit of magnetic flux, or in such a direction that when the one opening surface of the first coil antenna serves as an exit of magnetic flux, the one opening surface of the second coil antenna serves as an entrance of magnetic flux.

5. The antenna device according to claim 2, wherein
one coil antenna of the first and second coil antennas defines a feed element; and
the other coil antenna of the first and second coil antennas defines a non-feed element and is magnetically coupled to the one coil antenna.

6. The antenna device according to claim 2, wherein
the body has a stack structure including a plurality of insulating layers stacked in a direction intersecting the first and second main surfaces; and
the second coil antenna includes a planar coil located on a surface of at least one of a plurality of insulating layers that constitute the stack structure.

7. The antenna device according to claim 6, wherein the body includes:
a first region including one or more of the insulating layers;
a second region including one or more of the insulating layers provided between the first region and the second main surface; and
a third region provided between the first region and the second region and including one or more of the insulating layers having a permeability higher than a permeability of the first and second regions;
the first coil antenna includes a portion of the third region inside;
a portion of the coil conductor of the first coil antenna is provided at least one of inside and on a surface of the first region; and
the coil conductor of the second coil antenna is provided at least one of inside and on a surface of the first region.

8. The antenna device according to claim 6, wherein the body includes:
a first region including one or more of the insulating layers; and
a second region provided between the first region and the second main surface and having a permeability higher than a permeability of the first region; and
the coil conductor of the first coil antenna and the coil conductor of the second coil antenna are provided at least one of inside and on a surface of the first region.

9. The antenna device according to claim 2, wherein
the body is made of a ferromagnetic material; and
at least a portion of the coil conductor of the first coil antenna and at least portion of the coil conductor of the second coil antenna are provided on a surface of the body.

10. The antenna device according to claim 2, wherein
the antenna device further includes a conductive layer arranged adjacent to the first main surface so as to extend along the first main surface;
the conductive layer includes a hole portion passing through the conductive layer in a vertical direction and a notch portion reaching the hole portion;
when viewed two-dimensionally from a direction vertical to the first main surface, the hole portion of the conductive layer overlaps an opening surface of the second coil antenna on a side proximate to the conductive layer; and
when viewed two-dimensionally from a direction vertical to the first main surface, the coil conductor of the second coil antenna is covered with the conductive layer excluding the notch portion.

11. The antenna device according to claim 10, wherein when viewed two-dimensionally from a direction vertical to the first main surface, the notch portion is provided on a side opposite to the first coil antenna with the opening surface of the second coil antenna on the side proximate to the conductive layer.

12. The antenna device according to claim 2, wherein
the second main surface is a surface attached to a base material at least partially including a metal; and
the conductor layer constitutes at least a portion of the metal included in the base material.

13. The antenna device according to claim 3, wherein an outer diameter and an inner diameter of the coil conductor of the second coil antenna are greater than an outer shape and an inner diameter, respectively, of the coil conductor of the first coil antenna.

14. The antenna device according to claim 2, further comprising:
a third coil antenna including a coil conductor provided at least one of inside and on a surface of the body, and including a winding axis intersecting at least one of the one or more side surfaces;
when viewed two-dimensionally from a direction vertical to the first main surface, the third coil antenna is arranged on a side opposite to the first coil antenna with the second coil antenna interposed;
a direction of the winding axis of the third coil antenna is parallel or approximately parallel to a direction of the winding axis of the first coil antenna; and
the second and third coil antennas are arranged such that the second coil antenna is positioned farther from the second main surface than the first and third coil antenna.

15. The antenna device according to claim 2, further comprising:
a third coil antenna including a coil conductor provided at least one of inside and on a surface of the body, and including a winding axis intersecting the first and second main surfaces;
when viewed two-dimensionally from a direction vertical to the first main surface, the third coil antenna is arranged on a side opposite to the second coil antenna with the first coil antenna interposed; and
the first and third coil antennas are arranged such that the third coil antenna is positioned farther from the second main surface than the first coil antenna.

16. The antenna device according to claim 14, wherein the first, second and third coil antennas are connected in series or in parallel with an external feed circuit and are magnetically coupled to each other.

17. The antenna device according to claim 14, wherein
a portion of the first, second and third coil antennas defines a feed element; and
a remaining portion of the first, second and third coil antennas excluding the portion defines a non-feed element and is magnetically coupled to the portion.

18. An antenna device comprising:
first and second bodies each including first and second main surfaces opposed to each other and one or more side surfaces connected to the one and second main surfaces, each of the second main surfaces being attached to a common substrate;
a first coil antenna including a coil conductor provided at least one of inside and on a surface of the first body, and including a winding axis intersecting at least one of the one or more side surfaces of the first body;
a second coil antenna including a coil conductor provided at least one of inside and on a surface of the first body, and including a winding axis intersecting the first and second main surfaces of the first body;
a third coil antenna including a coil conductor provided at least one of inside and on a surface of the second body, and including a winding axis intersecting at least one of the one or more side surfaces of the second body;
a fourth coil antenna including a coil conductor provided at least one of inside and on a surface of the second body, and including a winding axis intersecting the first and second main surfaces of the second body; and
a conductor layer opposed to the second main surface of the first body and the second main surface of the second body; wherein
when viewed two-dimensionally from a direction vertical to the substrate, the second and fourth coil antennas are arranged on opposite sides to each other with the first and third coil antennas interposed;
a direction of the winding axis of the first coil antenna is parallel or approximately parallel to a direction of the winding axis of the third coil antenna;
the first and second coil antennas are arranged such that the second coil antenna is positioned farther from the second main surface of the first body than the first coil antenna; and
the third and fourth coil antennas are arranged such that the fourth coil antenna is positioned farther from the second main surface of the second body than the third coil antenna.

19. The antenna device according to claim 2, further comprising a coil-type booster antenna arranged in an area of the plurality of coil antennas and having an outer shape larger than an outer shape of the plurality of coil antennas.

20. A communication terminal apparatus comprising:
a casing;
a feed circuit provided in the casing;
a printed circuit board provided in the casing and including a ground layer; and
the antenna device of claim 2 provided in the casing and connected to the feed circuit; wherein
the conductor layer of the antenna device constitutes at least a portion of the ground layer.

21. The communication terminal apparatus according to claim 20, wherein
the body is provided at a position closer to one of opposite ends in a longitudinal direction of the casing; and
a direction of the winding axis of the first coil antenna is parallel or approximately parallel to the longitudinal direction of the casing.

22. The antenna device according to claim 2, wherein
the body includes a magnetic material region; and
at least a portion of the coil conductor of the first coil antenna and at least a portion of the coil conductor of the second coil antenna are provided on a surface or outside of the magnetic material region.
